(19) United States
(12) Patent Application Publication
(10) Pub. No.: US 2008/0254373 A1
(43) Pub. Date: Oct. 16, 2008

(54) Method of making PDR and PBR glasses for holographic data storage and/or computer generated holograms

(75) Inventor: Che-Kuang Wu, San Diego, CA (US)

Correspondence Address: Mitchell P. Brook;LUCE, FORWARD, HAMILTON & SCRIPPS LLP, 11988 EL CAMINO REAL, SUITE 200, SAN DIEGO, CA, 92130, US

(73) Assignee: CANYON MATERIALS, INC., San Diego, CA (US)

(21) Appl. No.: 11/787,052

(22) Filed: Apr. 13, 2007

(51) Int. Cl. G11B 7/0065

(52) U.S. Cl. 430/2

(57) ABSTRACT

Methods of making volume phase holograms and/or making computer-generated holograms using silver ion-exchanged silicate glass articles that include a photo-darkenable-refractive (PDR) glass plate and/or a photo-bleachable-refractive (PBR) glass plate. In one embodiment, a method of forming a volume phase hologram includes the steps of making a PBR glass plate that has at least one photosensitive glass layer of a silver ion-exchanged holographic recording (SIHR) glass, and of exposing the photosensitive glass layer to the bleaching-light radiation of laser write beams, causing the volume phase hologram to form in the photosensitive glass layer of the PBR glass plate. The base glass composition of the SIHR glass has been ion-exchanged in an aqueous ion-exchange solution containing silver ions. The SIHR glass is then uniformly darkened with darkening-light radiation. This process causes the photosensitive glass layer of the PBR glass plate to show a change in refractive index upon exposure to the bleaching-light radiation without any post-exposure treatment.

### BACKGROUND OF THE INVENTION

1. Field of the Invention

The present invention concerns glasses for the storage of holographic data and the related manufacturing methods. More particularly, the present invention concerns silver ion-exchanged silicate glass articles that include photo-darkenable-refractive (PDR) and photo-bleachable-refractive (PBR) glass plates.

2. Description of Related Art

Holographic data storage has been an active field of research and development worldwide for more than 40 years. The concepts of holographic data storage is based on storing in a suitable medium a large number of images, each consisting of a large array of picture elements or pixels.

In its simplest form, holographic data storage involves causing each pixel to become either bright or dark to encode a binary 1 or 0. Each image or page of data is stored in an optically sensitive material as an interference pattern formed by the interaction of a data-bearing light beam (that is, the information light beam) with a reference light beam.

A large number of data pages can be independently stored and read back within a single common volume of materials by using multiplexing techniques, such as wavelength multiplexing (changing the recording laser wavelength), angular multiplexing (changing the angle between the data-bearing light beam and reference beam), peristrophic multiplexing (physically rotating the hologram with the axis of rotation being perpendicular to the surface of the photosensitive recording film every time a new hologram is stored), and shift multiplexing (slightly displacing the recording medium and optics relative to each other such that holograms are partially overlapped). Because an entire page of data, consisting of megabits of data, is stored in or read out of the storage medium in parallel, the data rate can be quite large in principle, in the order of gigabits per second.

Advancement in holographic system technology were disclosed, among others, in U.S. Pat. No. 6,909,529 “Method and Apparatus for Phase Correlation Holographic Drive,” issued on Jun. 21, 2005 to K. R. Curtis; U.S. Pat. No. 6,995,882 “Apparatus for Recording Optical Information,” issued on Feb. 7, 2006 to H. Horimai; and U.S. Pat. No. 7,002,891 “Apparatus and Method for Recording and Reproducing Information to and from an Optical Storage Medium,” issued on Feb. 21, 2006 also to H. Horimai. In spite of the advancements disclosed in the above documents, holographic data-storage technologies remain limited primarily by the properties of the storage medium.

In particular, materials for holographic recording in high density optical storage applications require a combination of properties that include a high dynamic range, dimensional stability, high diffraction efficiency, high sensitivity, optical clarity (including low light scattering and absorption), long hologram lifetime, high speed (that is, a short time constant to build up a photo-refractive grating), a high optical quality (including homogeneous bulk refractive index and optical flatness), resistance to erasure during reading, and wavelengths for writing, reading and erasing that match practical and available laser wavelengths such as wavelengths of semiconductor diode lasers. Candidates materials for holographic optical storage include LiNbO₃ doped with Fe, Sr₁₋ₓ, Baₓ Nb₂O₆ (SBN) doped with Ce or Cr, BaTiO₃ undoped or doped with Rh, photorefractive polymers such as DuPont's HRF-150 photopolymer film, and photochromic films. Each of these material groups has its own strengths and weakness.

Among the above mentioned properties, optical quality is very important. When single crystals are employed, a common cause of poor optical quality is the presence of striations introduced in crystal growth processes, which causes scattering, that leads to interpixel interference in the recorded hologram as well as noise during readout of data. Bulk refractive index inhomogeneities lead to wave-front distortions that limit the ability to image high-resolution data patterns through the storage medium, thus data density. Even though the optical quality of LiNbO₃ may currently be the best available among the candidate ferroelectric photorefractive materials, the images transmitted through a LiNbO₃ single crystal are still significantly poorer than those formed through an optical glass plate.

The utility of photopolymers for data storage is generally limited by volume shrinkage and by the substantial amount of scattering and/or bulk refractive index inhomogeneity. Due to the high absorption losses usually observed in photochromic films, useful sample thickness is limited.

Based on the foregoing, a silicate glass plate of high optical quality that has a homogeneous bulk refractive index and that is optically flat would be a suitable candidate as a holographic recording material, provided that the combination of the other above listed properties is also attained.

U.S. Pat. No, 4,160,654, issued on Jul. 10, 1979 to Bartholomew, Mach and Wu, discloses a method of making a transparent, essentially colorless glass body, which exhibits thermoplastic properties and photosensitivity to ultraviolet radiation, and in which at least a surface portion contains Ag⁺ ions. This method includes the steps of melting a batch for an anhydrous glass body that essentially consists, in mole percent on oxide basis, of about 3-25% Na₂O and/or K₂O, 50-95% SiO₂, zero to 25% of at least one oxide selected from the group consisting of BaO, B₂O₃, CaO, PbO, and ZnO, zero to 35% MgO, zero to 20% Al₂O₃, zero to 10% Li₂O, and about 0.1-3% of a halide selected from the group consisting of F⁻, Cl⁻, Br⁻, and I⁻; and of contacting the anhydrous glass body in thickness dimensions no greater than about 5 mm with an aqueous solution environment containing Ag⁺ ions and having a pH less than about 4. The oxidation state of the glass is controlled both in the batch composition and in the aqueous solution environment; in particular, the oxidation state of the aqueous solution environment is controlled by including an oxidizing agent therein. Such a contact is made at a temperature in excess of 100° C. and at a pressure in excess of 20 psi for a period of time sufficient to hydrate at least a surface portion of the glass body, to attain an amount of absorbed H₂O effective for imparting thermoplastic properties to the surface portion having been hydrated, and to cause the replacement of Na⁺ and/or K⁺ ions with Ag⁺ ions in the hydrated glass. The proportion of Na⁺ and/or K⁺ ions in the hydrated glass is lower with a corresponding increase in Ag⁺ ions.

The thermoplastic properties of the photosensitive hydrated glasses according to the '654 patent have an adverse effect on dimensional stability. Since dimensional instability leads to Bragg detuning or rotations in the Bragg angles of recorded holograms, the silver-containing glasses of the '654 patent are not suitable for use as a holographic recording material.

U.S. Pat. No. 4,297,417, issued on Oct. 27, 1981 to Wu, discloses photosensitive colored glasses that exhibit alterable photo-anisotropic effects, and U.S. Pat. No. 4,191,547, issued on Mar. 4, 1980 also to Wu, discloses a method of making the same. Further, U.S. Pat. No. 4,296,479, issued on Oct. 20, 1981 to Wu, discloses a method for optical recording in photo-dichroic glass surfaces (the same glass surfaces as disclosed in U.S. Pat. No. 4,297,417). In particular, the '417 patent describes a photosensitive storage medium for storing optical information, which utilizes photo-anisotropic effects and which comprises a photosensitive colored glass article that exhibits alterable photo-anisotropic effects and that consists of a body portion and of an integral hydrated surface layer of a thickness of about 1-500 microns including Ag—AgCl-containing crystals therein. At least a portion of that hydrated surface layer exhibits photo-dichroic and birefringent properties when exposed to colored, linearly polarized bleaching light, and that body portion consists essentially, in mole-percent on oxide basis, of about 70-82% SiO₂, 10-17% Na₂O and/or K₂O, 5-15% ZnO, 0.5-5% Al₂O₃ and 0.1-3% Cl. That said surface layer contains instead about 1-8% by weight H₂O and about 2-20% by weight Ag, the proportion of Na⁺ and/or K⁺ ions in said surface layer being less with a corresponding increase in Ag⁺ ions. The Ag portion of those crystals is present as a layer on the surface of the crystals and/or is contained within the crystals.

A photo-dichroic glass surface is a bit-by-bit write-erasable storage medium. The write state (i.e.,1 bit) is accomplished by exposing the photo-dichroic glass surface to a write beam that includes a linearly polarized red light, and the erased state (i.e., zero bit) is accomplished by utilizing an erasing beam, which is the write beam whose polarization direction has been rotated about 45°. The mode of reading the stored image or data is done with a bit-by-bit extinction read mode between a pair of crossed polarizers. The read signal is obtained bit-by-bit via transmission of the read beam through a sequence of elements consisting of a polarizer, recorded bit in the photo-dichroic glass surface, and an analyzer, which is a second polarizer whose polarization direction is 90° from the first polarizer. This read mode utilizing the photo-anisotropic effects is not compatible with the requirement of holographic recording and retrieval, and the photosensitive colored glasses exhibiting alterable photo-anisotropic effects were demonstrated to be useful only as a write-erasable bit-by-bit recording material.

U.S. Pat. Nos. 4,670,306, issued on Jun. 2, 1987 to Wu, and U.S. Pat. No. 5,078,771, issued on Jan. 7, 1992 also to Wu, the contents of which are incorporated herein by reference, disclose a High Energy Beam Sensitive (HEBS) glass and a Laser Direct Write (LDW) glass prepared from HEBS glass by uniformly darkening the HEBS-glass with a flood electron beam. LDW-glass is a suitable candidate as a bit-by-bit optical recording material. Focused laser beam writing with a visible laser wavelength results in the ionization of atomic silver in LDW-glass and in converting the silver particles and/or specks in LDW-glass to silver ions, thus reverting the e-beam darkened glass layer at heat erased spots to transparent HEBS-glass. Therefore, an optical data bit with excellent contrast can be recorded in the LDW-glass plate. An experimental characterization of the LDW-glass plate for optical disk data storage is disclosed in “Characterization of Erasable Inorganic Photochromic Media for Optical Disk Data Storage” by X. Huang et al and C. Wu in J. Applied Physics, Vol. 83, No. 7, pages 3795-3799, published in April 1998. The optical recording of data is based on a heat erasure mode of recording that uses a focused laser beam to record data bit by bit. Since the e-beam darkened areas in a LDW-glass layer are heat erased at a temperature above about 200° C., heat spread from the recording bits to the surrounding bits causes the LDW-glass plate of U.S. Pat. No. 5,078,771 not to be a suitable candidate for holographic recording material.

U.S. Pat. No. 6,586,141, issued on Jul. 1, 2003 to Efimov et al, discloses a method of forming diffractive optical elements and holographic optical elements in photosensitive silicate glasses doped with silver, cerium, fluorine, and bromine. This process employs a photo-thermo-refractive (PTR) glass of high purity exposed to the ultraviolet (UV) radiation of a He—Cd laser at 325 nm wavelength, followed by thermal development at temperatures from 480° C. to 580° C. for a time duration of up to several hours. Absolute diffraction efficiency up to 95% was observed for 1 mm thick gratings. Maximum spatial frequency recorded in the PTR glass was about 10,000 mm⁻¹, and no decreasing of diffraction efficiency were detected at low spatial frequencies. However, due to the requirement of post-exposure thermal development steps, PTR glasses are not useful as a direct-read-after-write optical information recording medium for use in an optical system for recording and reproduction of information utilizing holography.

### SUMMARY OF THE INVENTION

In one embodiment, the present invention relates to a method of forming a volume phase hologram that includes the steps of making a photo-darkenable-refractive (PDR) glass plate having at least one photosensitive glass layer of a silver ion-exchanged holographic recording (SIHR) glass, and of exposing the photosensitive glass layer of the PDR glass plate to the darkening-light radiation of laser write beams, causing the volume phase hologram to be formed in the photosensitive glass layer of the PDR glass plate. The SIHR glass has a base glass composition that has been ion-exchanged in an aqueous ion-exchange solution containing silver ions, such to cause the photosensitive glass layer of the PDR glass plate to show a change in refractive index upon exposure to the darkening-light radiation without any post-exposure step that involves either a physical or chemical treatment.

In another embodiment, the present invention relates to a base glass composition that consists essentially, in mole percent of the oxide basis, of about 10-23% of one or more alkali metal oxides, about 4-18% ZnO, about 0.5-12% MgO, about 0.5-10% Al₂O₃, about 0.2-3.5% Cl, and about 54-78% SiO₂.

In still another embodiment, the base glass composition consists essentially, in mole percent of the oxide basis, of about 8-28% of one or more alkali metal oxides such as Li₂O, Na₂O, and K₂O, zero to about 24% ZnO, zero to about 10% Al₂O₃, zero to about 12% MgO, zero to about 8% ZrO₂, zero to about 10% CaO, zero to about 20% PbO, zero to about 15% B₂O₃, zero to about 30% P₂O₅, zero to about 4% TiO₂, about 0.1-9% Cl, zero to about 3% total of F, Br, and I, and about 50 to 86% SiO₂. The acid-durability-and-glass-network-strengthener (ADAGNS) is ZnO, ZrO₂, Al₂O₃, MgO, TiO₂, or PbO and is in an amount of about 5 to 35% in mole percent of the oxide basis, and the base glass composition has a concentration of the ADAGNS effective to render the photosensitive glass layer free of any thermoplastic property that may adversely affect the dimensional stability of the photosensitive glass layer for multiplex recording or for reproducing information utilizing holography. In still another embodiment, a base glass composition contains at least 4% of ZnO in mole percent of the oxide basis. In still another embodiment, the glass composition contains at least 2% of MgO in mole percent of the oxide basis. In still another embodiment, the base glass composition contains at least 0.5% of Al₂O₃ in mole percent of the oxide basis.

The photosensitive glass layer has a thickness of SIHR glass that ranges from about 5 to more than 500 micrometers and that is not limited by high absorption losses at selected read wavelengths, because the wavelength λₚ of at least one prominent absorption peak of atomic silver clusters is shifted to a shorter wavelength as exposure dosage of the darkening-light radiation on the SIHR glass increases.

The aqueous ion-exchange solution contains at least one oxidizing agent, preferably HNO₃ and a metal nitrate such as AgNO₃, LiNO₃, NaNO₃, KNO₃, Zn(NO₃)₂, among others. The aqueous ion exchange solution is acidic.

The laser write beams, in a photo energy darkening mode of recording that utilizes holography, have a wavelength selected from within a spectral range of about 250 nm to about 550 nm, and the photosensitive glass layer of the PDR glass plate is exposed using exposure dosages to the darkening-light radiation of the laser write beams that range from about 10 mJ/cm² to about 20,000 mJ/cm². The exposure dosage that is required to form the volume phase hologram is reduced by optimizing the concentration of MgO in the base glass composition.

The PDR glass plate can be utilized in an optical information recording medium for use in a holographic optical disc drive. The photosensitive glass layer of the PDR glass plate is a hologram layer in the optical information recording medium. The laser write beams consist of an information light beam and a reference light beam. Information light in the information light beam is reconstructed using a laser read beam that has a wavelength selected from about 500 nm to about 1100 nm. Preferably, the photosensitive glass layer of the PDR glass plate is optimized to have essentially no darkening as well as no bleaching sensitivity at the wavelength and/or at the intensity level of the laser read beam, and also is optimized to have a sufficiently large value of the refractive index change at the wavelength of the laser read beam for multiplex reproduction of the information light utilizing holography. Further, the photosensitive glass layer of the PDR glass plate is optimized to have a sufficiently low value of optical density at the wavelength of the laser read beam for multiplex reproduction of the information light utilizing holography. The optical density at the wavelength of the laser read beam has a sufficiently low value, because the composition of the SIHR glass is optimized and balanced to have the wavelength λₚ of at least one prominent absorption peak of atomic silver clusters shifted to a shorter wavelength as the exposure dosage of the darkening-light radiation on the SIHR glass is increased. One of the preferred laser read beam has a wavelength of about 780 nm.

The present invention also relates to a method of forming a volume phase hologram comprising the step of making a photo-bleachable-refractive (PBR) glass plate that has at least one photosensitive glass layer of a silver ion-exchanged holographic recording (SIHR) glass, and of exposing the photosensitive glass layer of the PBR glass plate to the bleaching-light radiation of laser write beams to form the volume phase hologram in the photosensitive glass layer of the PBR glass plate. The SIHR glass has a base glass composition that has been ion exchanged in an aqueous ion-exchange solution containing silver ions, and the SIHR glass has been darkened uniformly at least in lateral (that is, x, y) dimensions (which are perpendicular to the depth dimension z of ion exchange reaction) with darkening-light radiation, causing the photosensitive glass layer of the PBR glass plate to show a refractive index change upon exposure to bleaching-light radiation without any post-exposure steps, such as a physical or a chemical treatment. The uniformity of darkening of the SIHR glass along z direction with darkening-light radiation is predetermined by selecting the wavelength of the darkening radiation. Using a darkening radiation shorter than about 254 nm, the depth of the darkened SIHR glass layer is limited by the penetration depth of UV light due to attenuation by the SIHR glass. On the other hand, using a darkening radiation longer than about 365 nm, a substantially constant darkening along z direction is achieved. A uniformly darkened photosensitive glass layer of a larger thickness is obtained using a longer wavelength of the darkening-light radiation.

In one embodiment, a base glass composition consists essentially, in mole percent of the oxide basis, of about 10-23% of one or more alkali metal oxides, about 4-18% ZnO, zero to about 4% MgO, about 0.5-10% Al₂O₃, about 0.2 to 3.5% Cl, and about 54 to 78% SiO₂. In another embodiment, the base glass composition consists essentially, in mole percent of the oxide basis, of about 8-28% of one or more alkali metal oxides such as Li₂O, Na₂O, and K₂O, zero to about 24% ZnO, zero to about 10% Al₂O₃, zero to about 12% MgO, zero to about 8% ZrO₂, zero to about 10% CaO, zero to about 20% PbO, zero to about 15% B₂O₃, zero to about 30% P₂O₅, zero to about 4% TiO₂, about 0.1-9% Cl, zero to about 3% total of F, Br, and I, and 50 to 86% SiO₂, provided that the amount of an acid-durability-and-glass-network-strengthener (ADAGNS) selected from the group consisting of ZnO, ZrO₂, Al₂O₃, MgO, TiO₂, and PbO is about 5% to 35%, and that the base glass composition has a concentration of the ADAGNS effective to render the photosensitive glass layer free of any thermoplastic property that may adversely affect the dimensional stability of the photosensitive glass layer for multiplex recording or for reproducing information utilizing holography.

In still another embodiment, a base glass composition contains at least about 4% of ZnO in mole percent of the oxide basis, and in yet another embodiment, the base glass composition contains at least about 0.5% total of Al₂O₃, ZrO₂, and TiO₂ in mole percent of the oxide basis.

The darkening-light radiation is provided by an ultraviolet lamp and has wavelengths within a spectral range of about 250 nm to about 450 nm. The photosensitive glass layer which is a darkened SIHR glass has a thickness ranging from about 5 to more than 500 micrometer. In particular, the thickness of the SIHR glass is not limited by high absorption losses at selected read wavelengths, because the wavelength λₚ of at least one prominent absorption peak of atomic silver clusters is shifted to a shorter wavelength as exposure dosage of the darkening-light radiation on the SIHR glass is increased.

The aqueous ion exchange solution contains at least one oxidizing agent, preferably HNO₃ and a metal nitrate such as AgNO₃, LiNO₃, NaNO₃, KNO₃, Zn(NO₃)₂, among others. The aqueous ion exchange solution is acidic.

The laser write beams in photo energy bleaching mode of recording utilizing holography have a wavelength selected from within a spectral range of about 500 nm to about 750 nm. In photo energy bleaching mode of recording utilizing holography, the photosensitive glass layer of the PBR glass plate is exposed using exposure dosages of the bleaching-light radiation of the laser write beams that range from about 10 mJ/cm² to about 5,000 mJ/cm².

The PBR glass plate is utilized in an optical information recording medium for use in a holographic optical disc drive. The photosensitive glass layer of the PBR glass plate is a hologram layer in the optical information recording medium. The laser write beams consist of an information light beam and a reference light beam. Information light in the information light beam is reconstructed using a laser read beam that has a wavelength ranging from about 500 nm to about 1100 nm.

In one embodiment, the photosensitive glass layer of the PBR glass plate is balanced and/or optimized to have essentially no darkening and no bleaching sensitivity at the wavelength and/or at an intensity level of the laser read beam, and also to have a sufficiently large value of the refractive index change at the wavelength of the laser read beam for multiplex reproduction of the information light utilizing holography. Further, the photosensitive glass layer of the PBR glass plate is optimized to have a sufficiently low optical density value at the wavelength of the laser read beam for multiplex reproduction of the information light utilizing holography, because the composition of the SIHR glass is balanced and/or optimized to have the wavelength λₚ of at least one prominent absorption peak of atomic silver clusters shifted to a shorter wavelength as the exposure dosage of the darkening-light radiation on the SIHR glass is increased. The laser read beam may operate at the wavelength of the laser write beams and has a fraction of the intensity of the reference light beam.

The present invention also relates to an optical information recording medium that comprises a photo-bleachable-refractive (PBR) glass plate having at least one photosensitive glass layer of a silver ion-exchanged holographic recording (SIHR) glass, which includes a base glass composition that has been ion-exchanged in an aqueous ion-exchange solution containing silver ions. The SIHR glass is darkened uniformly at least in the lateral (x, y) dimensions (that is, perpendicular to thickness dimension of the photosensitive glass layer) with darkening-light radiation, so that the photosensitive glass layer of the PBR glass plate shows a change in refractive index change upon exposure to a bleaching-light radiation without any post-exposure steps, such as a physical or a chemical treatment. In one embodiment, the base glass composition consists essentially, in mole percent of the oxide basis, of about 10-23% of one or more alkali metal oxides, about 4-18% ZnO, zero to about 4% MgO, about 0.5-10% Al₂O₃, about 0.2 to 3.5% Cl, and about 54-78% SiO₂. In another embodiment, the base glass composition consists essentially, in mole percent of the oxide basis, of about 8-28% of one or more alkali metal oxides selected from the group consisting essentially of Li₂O, Na₂O, and K₂O, zero to about 24% ZnO, zero to about 10% Al₂O₃, zero to about 12% MgO, zero to about 8% ZrO₂, zero to about 10% CaO, zero to about 20% PbO, zero to about 15% B₂O₃, zero to about 30% P₂O₅, zero to about 4% TiO₂, about 0.1-9% Cl, zero to about 3% total of F, Br, and I, and 50 to 86% SiO₂, provided that the amount of an acid-durability-and-glass-network-strengthener (ADAGNS), selected from the group consisting of ZnO, ZrO₂, Al₂O₃, MgO, TiO₂, and PbO, is about 5 to 35%, and that the base glass composition has a concentration of the ADAGNS effective to render the photosensitive glass layer free of any thermoplastic property that may adversely affect the dimensional stability of the photosensitive glass layer for multiplex recording or for reproducing information utilizing holography. In another embodiment, the base glass composition contains at least-about 4% of ZnO in mole percent of the oxide basis. In still another embodiment, the base glass composition contains at least about 0.5% total of Al₂O₃, ZrO₂, and TiO₂ in mole percent of the oxide basis.

The darkening-light radiation is from an ultraviolet lamp and has wavelengths within a spectral range of about 250 nm to about 450 nm. The photosensitive glass layer, which is a darkened SIHR glass, has a thickness of about 5 or more micrometers. The thickness of the SIHR glass is not limited by high absorption losses at selected read wavelengths, because the wavelength λₚ of at least one prominent absorption peak of atomic silver clusters is shifted to a shorter wavelength as exposure dosage of the darkening-light radiation on the SIHR glass increases.

The aqueous ion exchange solution contains at least one oxidizing agent, preferably selected from the group consisting of HNO₃ and nitrates of metals that include AgNO₃, LiNO₃, NaNO₃, KNO₃, Zn(NO₃)₂, as well as other metal nitrates. The aqueous ion exchange solution is acidic.

The optical information recording medium is used in an optical system such as a holographic optical disc drive for multiplex recording or for reproducing of information utilizing holography. In a photo energy bleaching mode of recording utilizing holography, the photosensitive glass layer of the PBR glass plate is exposed using exposure dosages of the bleaching-light radiation of laser write beams that range from about 10 mJ/cm² to about 5,000 mJ/cm² and that have a wavelength selected from within a spectral range of about 500 nm to about 750 nm; for example, the laser write beams may have a wavelength of 650 nm.

The photosensitive glass layer of the PBR glass plate is a hologram layer in the optical information recording medium. The laser write beams consist of an information light beam and a reference light beam. Information light in the information light beam is reconstructed using a laser read beam that has a wavelength selected from about 500 nm to about 1100 nm; for example, the laser read beam can have a wavelength of about 780 nm. In one embodiment, the photosensitive glass layer of the PBR glass plate is balanced and/or optimized to have essentially no darkening as well as no bleaching sensitivity at the wavelength and/or at the intensity level of the laser read beam, and also to have a sufficiently large value of the refractive index change at the wavelength of the laser read beam for multiplex reproduction of the information light utilizing holography. The photosensitive glass layer of the PBR glass plate is also optimized to have a sufficiently large transmittance value at the wavelength of the laser read beam for multiplex reproduction of the information light utilizing holography. The optical density at the wavelength of the laser read beam has a sufficiently low value, because the composition of the SIHR glass is balanced and/or optimized to have the wavelength λₚ of at least one prominent absorption peak of atomic silver clusters shifted to a shorter wavelength as the exposure dosage of the darkening-light radiation on the SIHR glass increases. The laser read beam can have the wavelength of the laser write beams and has a fraction of the intensity of the reference light beam. Additionally, the optical information recording medium may include a reflecting film.

The present invention also relates to an optical information recording medium that comprises a photo-darkenable-refractive (PDR) glass plate having at least one photosensitive glass layer of a silver ion-exchanged holographic recording (SIHR) glass. The SIHR glass has a base glass composition that has been ion-exchanged in an aqueous ion-exchange solution containing silver ions, causing the photosensitive glass layer of the PDR glass plate to exhibit a refractive index change upon exposure to darkening-light radiation without any post-exposure steps, such as a physical or a chemical treatment.

In one embodiment, the base glass composition consists essentially, in mole percent of the oxide basis, of about 10-23% of one or more alkali metal oxides, about 4-18% ZnO, about 0.5-12% MgO, about 0.5-10% Al₂O₃, about 0.2 to 3.5% Cl, and about 54 to 78% SiO₂. In another embodiment, the base glass composition consists essentially, in mole percent of the oxide basis, of about 8-28% of one or more alkali metal oxides such as Li₂O, Na₂O, and K₂O, zero to about 24% ZnO, zero to about 10% Al₂O₃, zero to about 12% MgO, zero to about 8% ZrO₂, zero to about 10% CaO, zero to about 20% PbO, zero to about 15% B₂O₃, zero to about 30% P₂O₅, zero to about 4% TiO₂, about 0.1-9% Cl, zero to about 3% total of F, Br, and I, and 50-86% SiO₂, provided that the amount of an acid-durability-and-glass-network-strengthener (ADAGNS), selected from the group consisting of ZnO, ZrO₂, Al₂O₃, MgO, TiO₂, and PbO, is about 5 to 35%, and that the base glass composition has a concentration of the ADAGNS effective to render the photosensitive glass layer free of any thermoplastic property that may adversely affect the dimensional stability of the photosensitive glass layer for multiplex recording or reproduction of information utilizing holography. In still another embodiment, the base glass composition contains at least 4% of ZnO in mole percent of the oxide basis. In yet another embodiment, the base glass composition contains at least 2% of MgO in mole percent of the oxide basis. In a further embodiment, the base glass composition contains at least 0.5% of Al₂O₃ in mole percent of the oxide basis.

The photosensitive glass layer has a thickness of SIHR glass of about 5 or more micrometers. The thickness of the SIHR glass is not limited by high absorption losses at selected read wavelengths, because the wavelength λₚ of at least one prominent absorption peak of atomic silver clusters is shifted to a shorter wavelength as exposure dosage of the darkening-light radiation on the SIHR glass increases. The aqueous ion exchange solution contains at least one oxidizing agent, preferably selected from the group consisting of HNO₃ and nitrates of metals that include AgNO₃, LiNO₃, NaNO₃, KNO₃, Zn(NO₃)₂, and other metal nitrates. The aqueous ion-exchange solution is acidic.

The optical information recording medium is used in an optical system such as a holographic optical disc drive for multiplex recording or reproduction of information utilizing holography. In a photo energy darkening mode of recording utilizing holography, the photosensitive glass layer of the PDR glass plate is exposed by using exposure dosages of the darkening-light radiation of laser write beams that range from about 10 mJ/cm² to about 20,000 mJ/cm². The exposure dosage that is required to form the volume phase hologram is reduced by optimizing the concentration of MgO in the base glass composition.

The laser write beams in photo energy darkening mode of recording utilizing holography have a wavelength selected from within a spectral range of about 250 nm to about 550 nm; for example, the laser write beams may have a wavelength of about 405 nm. The photosensitive glass layer of the PDR glass plate is a hologram layer in the optical information recording medium. The laser write beams consist of an information light beam and a reference light beam. Information light in the information light beam is reconstructed using a laser read beam that has a wavelength selected from about 500 nm to about 1100 nm; for example, the laser read beam may have a wavelength of about 780 nm. In one embodiment, the photosensitive glass layer of the PDR glass plate is balanced and/or optimized to have essentially no darkening as well as no bleaching sensitivity at the wavelength and/or at an intensity level of the laser read beam, and also to have a sufficiently large value of the refractive index change at the wavelength of the laser read beam for multiplex reproduction of the information light utilizing holography. In addition, the photosensitive glass layer of the PDR glass plate is also optimized to have a sufficiently large transmittance value at the wavelength of the laser read beam for multiplex reproduction of the information light utilizing holography, because the composition of the SIHR glass is optimized to have the wavelength λₚ of at least one prominent absorption peak of atomic silver clusters shifted to a shorter wavelength as the exposure dosage of the darkening-light radiation on the SIHR glass increases.

The optical information recording medium may also include a reflecting film.

The use of volume diffractive optical elements as angular selector, spatial filter, attenuator, switcher, modulator, beam splitter, beam sampler, beam deflectors controlled by positioning of grating matrix, by a small-angle master deflector or by spectral scanning, selector of particular wavelengths (notch filter, add/drop element, spectral shape former (gain equalizer), spectral sensor (wavelength meter/wavelocker), angular sensor (pointing locker), Bragg spectrometer (spectral analyzer), transversal and longitudinal mode selector in laser resonator were described n U.S. Pat. No. 6,673,497, issued on Jun. 6, 2004 to Efimov et al, which is incorporated herein by reference.

### BRIEF DESCRIPTION OF THE DRAWINGS

FIG. 1 is a graphical representation of the spectral absorption bands of atomic silver clusters in a SIHR glass at various darkening-light exposure levels.

FIG. 2 is a graphical representation of the sensitivity of SIHR glasses to darkening-light radiation, showing an increase in such sensitivity by the addition of MgO as a batch ingredient in the base glass composition.

FIG. 3 illustrates D(λ) vs. λ spectra of an exemplary PDR glass plate, the wavelength of the write beam in a photo darkening mode of recording being shown as a variable parameter in this figure.

FIG. 4 is a graphical representation of the blue shift of the wavelength of the absorption peak of atomic silver clusters in an exemplary SIHR glass with an increasing exposure dosage of darkening-light radiation.

FIGS. 5a-5g illustrate the function Δn(Δλ, Dₚ) vs. Δλ, wherein in FIG. 5a Dₚ=1.2 and Δλ=λ−λₚ, in FIG. 5b Dₚ=1.75 and Δλ=λ−λₚ, in FIG. 5c Dₚ=2.35 and Δλ=λ−λₚ, in FIG. 5d Dₚ=2.85, and Δλ=λ−λₚ, in FIG. 5e Dₚ=3.35 and Δλ=λ−λₚ, in FIG. 5f Dₚ=3.8 and Δλ=λ−λₚ, and in FIG. 5g Dₚ=4.25 and Δλ=λ−λₚ.

FIG. 6 illustrates the function |Δn(Δλ, Dₚ))| vs. Dₚ, wherein Δλ=λ−λₚ, λₚ=620 nm and λ is a variable parameter.

FIG. 7 illustrates the function Δ|Δn| vs. Dₚ, wherein Δ|Δn| is a change in Δn arising from λₚ of a PBR glass plate being shifted by exposure to a bleaching write beam.

FIG. 8 illustrates D(λ) vs. λ spectra of an exemplary PBR glass plate, wherein curve A shows the spectra before exposure to a bleaching write beam, curve B and C record the optical density spectra of a plane polarized red laser bleached area using a probing beam that is plane-polarized respectively in a parallel direction and in a perpendicular direction.

FIG. 9a illustrates the function ΔD(λ) vs. λ, wherein the difference OD spectrum ΔD(λ) is D(λ) of spectral curve B of FIG. 8 minus D(λ) of spectral curve A of FIG. 8.

FIG. 9b illustrates the function ΔD(λ) vs. λ, wherein the difference OD spectrum ΔD(λ) is D(λ) of spectral curve C of FIG. 8 minus D(λ) of spectral curve A of FIG. 8.

FIG. 10a illustrates the propagation directions of laser write beams that is interferenced within a photosensitive glass layer of either a PDR glass plate or a PBR glass plate to form a phase volume transmitting diffractive grating. FIG. 10b illustrates the index modulation of the volume diffractive grating of FIG. 10a in a PBR glass plate.

FIG. 11a depicts a portion of optical elements in a prior art holographic optical disc drive. FIG. 11b illustrates a hologram being created only after at least one of the reference beam and the information beam have reflected off a data reflective surface.

FIG. 12 illustrates exemplary structures of the optical information recording medium of the present invention.

### DETAILED DESCRIPTION OF EMBODIMENTS OF THE INVENTION

Detailed descriptions of embodiments of the invention are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

The present invention concerns glasses for the storage of holographic data and for making computer-generated holograms therein, and the related manufacturing methods. More particularly, the present invention concerns silver ion-exchanged silicate glass articles that include photo-darkenable-refractive (PDR) and photo-bleachable-refractive (PBR) glass plates.

In one embodiment, a PDR glass plate has at least one photosensitive glass layer of a silver ion-exchanged holographic recording (SIHR) glass, in which a base glass composition has been ion-exchanged in an aqueous ion-exchange solution containing silver ions. This process causes the photosensitive glass layer of the PDR glass plate to show a refractive index change upon exposure to darkening-light radiation without any post-exposure step such as a physical or a chemical treatment, because the exposure to the darkening-light radiation causes formation of atomic silver cluster species in the SIHR glass.

In another embodiment, a PBR glass plate has at lease one photosensitive glass layer of a silver ion-exchanged holographic recording (SIHR) glass, in which a base glass composition has been ion-exchanged in an aqueous ion-exchange solution containing silver ions. The SIHR glass is then uniformly darkened with darkening-light radiation. This process causes the photosensitive glass layer of the PBR glass plate to show a refractive index change upon exposure to bleaching-light radiation without any post-exposure step such as a physical or a chemical treatment, because the exposure to the bleaching light radiation causes transformation of at least a portion of one silver cluster species into another silver cluster species within the uniformly darkened SIHR glass.

An optical information recording medium constructed in accordance with the principles of the present invention includes a PDR glass plate, in which the SIHR glass of the PDR glass plate is optimized for multiplex recording and for reproducing information that utilizes holography using darkening light radiation as recording beams.

Another optical information recording medium constructed in accordance with the principles of the present invention includes a PBR glass plate, in which the SIHR glass of the PBR glass plate is optimized for multiplex recording and for reproducing information that utilizes holography using bleaching light radiation as recording beams.

In one embodiment, SIHR glasses according to the present invention are produced through the ion-exchange of Ag⁺ ions for Li⁺, Na⁺ and/or K⁺ ions in a parent/base glass composition within a Li₂O, Na₂O, and/or K₂O—ZnO—Cl—SiO₂ silicate glass composition, most preferably in an acidic aqueous solution of silver salt, for example, AgNO₃. Upon ion-exchange most or all of the silver in the SIHR glass remains in the ionic state until exposure to darkening radiation, and such exposure results in the instantaneous formation of silver color centers and/or atomic silver species. The darkening radiation is selected from the group consisting of darkening-light radiation and high energy electron beams. One or more distinct types of aggregation of atomic silver cluster species may exist in a darkened SIHR glass, for example, either one or two types of atomic silver cluster species may exist in the darkened SIHR glass having been exposed to a darkening-light radiation or to an electron beam with more than about 5 kV accelerating voltage. In general, the darkening-light radiation of a SIHR glass is the light radiation that has a wavelength or a wavelength range selected from the spectral range of UV light, near UV light, blue light, and green light.

The photosensitive glass layer of a PDR glass plate is a silver ion-exchanged glass layer consisting of a SIHR glass, and the photosensitive glass layer of a PBR glass plate is a silver ion-exchanged glass layer consisting of a uniformly darkened SIHR glass.

A method of preparing a base glass or the parent anhydrous glass useful for preparing a SIHR glass comprises the steps of:
(a) preparing a pre-melt batch for the base glass by thoroughly combining and mixing powdered oxides or salts of alkali metals, zinc, silicon, and halides or other suitable materials in appropriate proportions to yield a base glass composition followed by the melt step described below;
(b) melting the pre-melt batch or mixture to form a glass melt; and
(c) cooling the glass melt.

Oxides and salts may be used in the preparation of the pre-melt batch, for example, oxides, halide salts, nitrate salts, carbonate salts, bicarbonate salts, silicate salts and other similar materials. Preferably, the glass melt is stirred during the melting step to form a uniform glass composition. Prior to cooling, the glass melt may be formed into a glass article, such as a glass sheet or plate. As is known in the art of silicate glass making, the glass article may be annealed at an annealing temperature T_{A} and cooled down slowly from T_{A}, so that it is absent of any stress birefringence and can be cut, ground and polished without breakage due to thermal stress.

The base glass composition is defined herein as the composition of a pre-melt batch.

To obtain a maximum Cl concentration in the base glass, the base glass composition is compounded with an excess of Cl-containing salts. During melting, some Cl will evaporated off, but the resulting melt and the cooled glass will be saturated or super saturated with respect to Cl. Cl saturation can be increased by performing the melt under a partial or complete Cl or chloride atmosphere. In one embodiment, the melting is done in an atmosphere containing at least a partial pressure of chlorine or chlorides.

The surface of the glass articles formed from the melt after cooling and annealing can be ground and polished to any desired surface figure or to a surface of any desired optical quality. If the glass article is a glass sheet or plate, the major opposing surfaces of the glass sheet can be ground to form a plate or sheet of the desired uniform thickness and then polished to form smooth, planar surfaces.

Volatilization of halides can be quite high during melting, particularly where temperatures in the upper extreme of the melting range are employed. Thus, halide losses of more than 20% are common. Besides being essential ingredients, halides also are a fining agent for the glass melts.

It will be appreciated that large melts of glass can be made in pots or continuous melting units in accordance with known commercial glass making practice. Where glass of optical quality is to be produced from commercial continuous melting tanks, the melt will be stirred in accordance with conventional practice. Volatilization of halides in such commercial melting practices can be held below 50% and, with proper care, below 10%. Retention of halides can be further increased by melting in a halogen-containing atmosphere.

A base glass compositions suitable for preparing a SIHR glass comprises, in mole percent, about 8-28% of one or more alkali metal oxides, 3-24% ZnO, 0.2-3% Cl, 50-89% SiO₂, and up to about 12% MgO. Preferably the composition contains at least 0.5% MgO, and most preferably contains at least 2% MgO in the SIHR glass of a PDR glass plate, and the composition contains less than about 4% MgO in the SIHR glass of a PBR glass plate.

The base glass composition also preferably contains at least one of the following constituents, in mole percent: zero-about 10% CaO, zero-about 8% ZrO₂, zero-about 10% Al₂O₃, zero-about 4% TiO₂, zero-about 10% SrO, zero-about 20%, PbO, zero-about 20% BaO, zero-about 30% P₂O₅, zero-about 15% B₂O₃ and/or zero-about 4% F, Br, I or a mixture thereof. Further, the base glass composition preferably contains an amount of an acid-durability-and-glass-network-strengthener (ADAGNS) selected from the group consisting of ZnO, ZrO₂, Al₂O₃, MgO, TiO₂, and PbO from about 5% to about 35%. Still further, the base glass most preferably contains about 5 to 20% of ZnO, Al₂O₃, ZrO₂ or a mixture thereof as ADAGNS. The concentration of ADAGNS in the glass composition is sufficient to prevent SIHR glass from being excessively hydrated and/or to prevent SIHR glass from becoming water soluble, and/or to maintain the optical quality surface of the glass plate during the ion-exchange process of producing the SIHR glass. The base glass composition of a SIHR glass is so designed that the SIHR glass is absent of excessive hydration, which excessive hydration may impart an undesirable thermoplastic property to the SIHR glass.

One base glass composition includes, in mole percent, about 2%-about 20% ZnO, zero-about 10% Al₂O₃, and about 1.2-about 12% MgO. Another base glass composition includes, in mole percent, about 3%-about 10% MgO and about 60%-about 82% SiO₂.

Suitable alkali metal oxides are Li₂O, Na₂O, K₂O, Rb₂O, and Cs₂O, with Li₂O, Na₂O and K₂O being preferred for the base glass. The base glass composition may contain at least two of the alkali metal oxides selected from Li₂O, Na₂O, and K₂O; for example, the base glass composition may contain about 10 to about 20 mole percent of Li₂O, Na₂O, K₂O or of a mixture thereof, and about 1 to 3 mole percent Cl.

The total quantity of constituents in the base glass composition of a pre-melt batch shall equal 100 mole percent. All mole percents are based on a mole percent oxide basis except for Cl, F, Br, and I, which are based on a mole percent element basis.

Although the constituents of the anhydrous base glass compositions are identified as specific chemical oxides or elements pursuant to the practice of the glass art, it is to be understood that such identification is for convenience only, in accordance with the practice of the glass art. As those skilled in the glass art will recognize, the chemical structure and coordination of all cations in glass are not known at present with complete certainty.

One base glass composition useful for preparing a SIHR glass comprises, in mole percent, about 12-24% Li₂O, Na₂O, K₂O or a mixture thereof, zero to about 10% MgO, about 4-14% ZnO, about 0.5-5% Al₂O₃, about 0.4-3% Cl, and about 65-75% SiO₂. The base glass composition may include, in mole percent, zero-about 10% ZrO₂, zero-about 15% CaO, zero-about 15% SrO, zero-about 15% BaO, zero-about 15% PbO, zero-about 35% B₂O₃, and/or zero-about 3% F, Br, I or a mixture thereof.

A preferred base glass composition for preparing SIHR glass articles comprises, in mole percent, about 13-24% of a mixture of Li₂O, Na₂O and K₂O; about zero-8% MgO; about 6.5-9.5ZnO; about 1-2% Al₂O₃; about 0.7-3% Cl and about 69-72% SiO₂. The base glass composition may also contain an amount of Cl equivalent to the Cl saturation value of the melt of the base glass composition.

It has been found that the base glass composition has a significantly adverse effect on the properties of the SIHR glass if the glass batch is contaminated with certain impurities, such as a carbon containing substance or a thermal reducing agent that affect the oxidation state of the glass melt.

It has been determined that the production of a SIHR glass article exhibiting darkening sensitivity to UV radiation and to longer wavelengths involves a complex combination of relationships among the various components of the base glass composition, the ingredients of the ion-exchange solution, and the conditions of the ion-exchange reactions. Nevertheless, there exists a very wide range of glass compositions in the field of alkali metal zinc silicate glasses that are suitable as a base for the products manufactured according to the present invention. The sensitivity to actinic radiation of SIHR glasses is strongly dependent upon the ingredients of the aqueous ion-exchanged solution, in particular, upon the concentrations of the silver ion and hydrogen ion.

The SIHR glass are prepared by treating a glass article having a base glass composition with a silver salt-containing material at a temperature sufficient to generate an ion-exchange reaction between the silver ions in the silver salt-containing material and the alkali metal ions in the base glass composition. The ion-exchange reaction is continued for a period of time sufficient to have the ion-exchange reaction proceed to a depth of at least 5 micrometer into the surface of the glass article to produce an ion-exchanged glass article, for example, a PDR glass plate, having a body portion composed of the base glass composition and an integral ion-exchanged surface glass layer that is the photosensitive glass layer composed of the SIHR glass.

The SIHR glass contains, in addition to a high concentration of ionic silver, silanol and/or water species in a concentration greater than about 0.01% by weight H₂O. The concentration of the alkali metal oxides in the SIHR glass is less than the concentration of the alkali metal oxides in the base glass composition. The thickness of the body portion may be reduced to zero when the ion-exchange process is allowed to proceed throughout the thickness dimension, in particular when the glass article is in a plate form of less than about 1 mm thickness.

Hydration and/or an exchange of H⁺ and/or H₃O⁺ ions for alkali metal ions in the base/parent glass article is expected to take place when the ion-exchange reactions are carried out in an aqueous solution containing Ag⁺ ions. The base glass compositions are designed so that the SIHR glass does not contain an excessive concentration of water species, because an excessive concentration of water species would impart thermoplastic properties to the hydrated glass and would have an adverse effect on the dimensional stability of the SIHR glass for use as a holographic recording material. Therefore, the base glass composition of a SIHR glass is designed and selected so that there is no thermal plastic properties in the SIHR glass layer. One SIHR glass embodiment contains less than about 2% by weight H₂O. Another SIHR glass embodiment contains less than about 1% by weight H₂O.

In cases where other ingredients such as cupric and/or cuprous oxide or gold oxide are included in an aqueous ion-exchange solution, additional reactions that exchange the alkali metal ions in the surface layer of the parent silicate glass with the other cations in the aqueous solution are also expected to take place, but to a lesser extent than with the Ag⁺ ion.

The ion-exchange reactions can be carried out as follows. The glass articles are immersed into an aqueous ion-exchange solution containing Ag⁺ ions and other ingredients, and the glass articles together with the aqueous solution are sealed in an autoclave and heated to a temperature sufficient to effect an ion-exchange reaction between the silver ions in the aqueous solution and the alkali metal ions in the glass article, usually above about 200° C. Reaction temperature is held for a duration of more than about 1 minute, and when a desired thickness of the ion-exchanged glass layer is obtained, the autoclave is cooled down to about room temperature. Thereafter, the glass articles having a photosensitive glass layer of SIHR glass are removed from the autoclave and washed with distilled water.

The concentration of silver ions in the aqueous ion-exchange solution according to the principles of the present invention is found to range from less than 10⁻³ mole/liter up to the concentration of a saturated AgNO₃ aqueous solution, while the concentration of hydrogen ion/hydronium ion can range from 10⁻⁶ to more than 3 moles per liter of the aqueous ion-exchange solution. The optimum concentration of silver ions in the aqueous ion-exchange solution, in general, increases with the concentration of hydrogen ion in the aqueous solution for preparing SIHR glasses. The hydrogen ions are added to the aqueous ion-exchange solution in the form of one or more acids, such as HNO₃, H₂SO₄, acetic acid, and the like.

The concentration of Ag⁺ ions in the SIHR glass can be varied from less than 1% up to more than 30% by weight of Ag₂O through various combinations of the concentrations of Ag⁺ ions and H⁺ ions in the aqueous ion-exchange solution, and of the temperature and duration of the ion-exchange reaction. One way to ensure a large concentration of Ag⁺ ions within the SIHR glass is to utilize an aqueous ion-exchange solution having a large concentration of Ag⁺ ions, that is, greater than about 100 g AgNO₃/liter of the aqueous solution. Another way to ensure a large concentration of Ag⁺ ions within the SIHR glass is to employ an aqueous ion-exchange 150° C. up to the softening point of the SIHR glass on the surface of the parent glass article and/or up to the strain point of the anhydrous base glass are operable. The temperature and duration of the ion-exchange reaction in combination with the choice of a base glass composition determines solution having a large mole ratio of [Ag⁺]:[H⁺], that is, in excess of 10, which is readily obtainable by buffering the aqueous solutions at a pH value selected from 2 to 5 with a buffering agent.

Cuprous oxide can be advantageously added to the aqueous ion-exchanged solution to cause the solution to buffer at a desirable pH, particularly in the pH range of 1 to 3, and most effectively in the pH range of 2 to 3. It also has been determined that the inclusion of cuprous and/or cupric ions in the aqueous ion-exchange solution can have some effect on the light radiation exposure-induced coloration of the SIHR glass articles.

Ion-exchange temperatures in excess of the rate of depth penetration of the ion-exchange reaction into the body portion of the glass article. A depth of penetration ranging from 5 to 200 micrometer is obtained in about 10 minutes to about 24 hours of ion-exchange at a temperature selected from about 200° C. to about 370° C., using a base glass composition such as the exemplary compositions listed in Table 1.

TABLE 1
Exemplary Base Glass Compositions

| | GLASS NO. | | | | | | |
|---|---|---|---|---|---|---|---|
| | 1 | 2 | 3 | 4 | 5 | 6 | 7 |
| SiO₂ | 71.51 | 73.58 | 58.22 | 60.32 | 58.51 | 57.90 | 58.52 |
| Na₂O | 8.69 | 8.94 | 18.36 | 13.39 | 12.86 | 9.39 | 7.46 |
| K₂O | 2.39 | 2.46 | 3.55 | 3.52 | 3.41 | 3.58 | 3.62 |
| Li₂O | 3.12 | 3.21 | | 2.13 | 2.07 | 5.46 | 5.51 |
| MgO | 2.82 | | | 2.87 | 2.91 | 2.70 | 5.76 |
| ZnO | 7.21 | 7.42 | 7.61 | 10.73 | 13.41 | 13.89 | 12.01 |
| Al₂O₃ | 1.20 | 1.23 | 3.67 | 3.93 | 3.81 | 3.95 | 3.99 |
| PbO | | | | | | | |
| TiO₂ | | | | | | | |
| B₂O₃ | | | | | | | |
| ZrO₂ | | | | | | | |
| Cl | 3.06 | 3.15 | 8.59 | 3.11 | 3.02 | 3.13 | 3.13 |
| | GLASS NO. | | | | | | |
| | 8 | 9 | 10 | 11 | 12 | 13 | 14 |
| SiO₂ | 68.82 | 63.20 | 60.60 | 71.62 | 69.49 | 62.78 | 71.34 |
| Na₂O | 11.04 | 13.39 | 9.39 | 10.66 | 11.16 | 18.36 | 8.94 |
| K₂O | 3.48 | 3.52 | 3.58 | 3.36 | 3.52 | 3.55 | 2.46 |
| Li₂O | 1.09 | 2.13 | 5.46 | | | | 3.21 |
| MgO | | | | 2.90 | | | |
| ZnO | 11.16 | 10.73 | 13.89 | 7.21 | 11.28 | 7.61 | 7.42 |
| Al₂O₃ | 1.23 | 3.93 | 3.95 | 1.19 | 1.24 | 3.67 | 1.23 |
| PbO | | | | | | | |
| TiO₂ | | | | | | 1.02 | |
| B₂O₃ | | | | | | | 2.25 |
| ZrO₂ | | | | | | | |
| Cl | 3.18 | 3.11 | 3.13 | 3.06 | 3.22 | 3.01 | 3.15 |

GLASS NO.

| | 15 | 16 | 17 | 18 | 19 | 20 |
|---|---|---|---|---|---|---|
| SiO₂ | 72.72 | 71.51 | 67.84 | 69.20 | 67.18 | 65.90 |
| Na₂O | 10.94 | 8.69 | 5.96 | 6.08 | 6.87 | 6.74 |
| K₂O | 3.46 | 2.39 | 3.24 | 1.31 | 2.24 | 3.15 |
| Li₂O | | 3.12 | 6.94 | 7.08 | 6.87 | 6.74 |
| MgO | | 2.82 | 5.16 | 5.26 | 5.11 | 5.01 |
| ZnO | 7.42 | | 6.83 | 6.97 | 7.74 | 8.54 |
| Al₂O₃ | 1.23 | 1.20 | 1.14 | 1.16 | 1.13 | 1.10 |
| PbO | | 7.21 | | | | |
| TiO₂ | | | | | | |
| B₂O₃ | | | | | | |
| ZrO₂ | 1.08 | | | | | |
| Cl | 3.15 | 3.06 | 2.89 | 2.94 | 2.86 | 2.82 |

As a matter of convenience, the ion-exchange reactions of the present invention will preferably be carried out in an autoclave, because such an apparatus permits a relatively easy control of the ion-exchange temperature, pressure, and atmosphere. To prevent the water in the aqueous ion-exchange solution from evaporating off during the ion-exchange reaction when conducted at elevated temperatures, the pressure of the autoclave can be maintained at the saturated vapor pressure of the ion-exchange solution or higher. Very high pressures can be utilized, although they are not required. Inert and/or oxidizing gases including N₂, air, O₂ and Ar can be advantageously added, usually at room temperature, to the vapor phase above the aqueous ion-exchange solution in the autoclave.

The filling factor, which is herein defined as the fractional volume of the autoclave occupied by the aqueous ion-exchange solution at room temperature, is another ion-exchange reaction parameter. The maximum allowable filling factor, which is herein defined as the filling factor at which the volume of the vapor phase in the autoclave diminishes at the ion-exchange temperature, should never be approached for safety reasons. However, when the filling factor is kept excessively below the maximum allowable filling factor, the concentration of the ingredients in the aqueous ion-exchange solution at elevated temperatures can be significantly different from the concentration at room temperature.

A large number of base glass compositions were melted and formed into glass plates, then ground and polished to 2 mm thickness. The glass plates were ion-exchanged in an acidic aqueous solution containing Ag⁺ ions to produce SIHR glass plates. Table 1 records the base glass compositions of SIHR glass plates No. 1 to No. 20. The thickness of SIHR glass layer increased with ion-exchange time duration. SIHR glass layers of about 100 μm were produced in about 2 to 64 hours depending on the base glass composition, in particular on the concentration of alkali metal oxides. The maximum thickness of the photosensitive glass layer of SIHR glass was limited to about 600 μm for many of the base glass compositions, due to dissolution, due to surface deterioration, or due to crystallization resulting from the concurrent hydration process during the silver ion-exchange in an aqueous solution.

Each of the base glass compositions of Table 1 contains one or more alkali metal oxides selected from the group consisting of Li₂O, Na₂O, and K₂O. When a base glass plate is immersed in an acidic aqueous solution containing Ag⁺ ions, alkali metal ions in the silicate glass network diffuse out of the silicate glass network and facilitate the diffusion of Ag⁺ ions and H⁺ ions into the silicate glass network. This phenomenon is referred to herein as a silver ion-exchange reaction. Upon the silver ion-exchange reaction, at least some, and preferably most or all of the silver ions in the SIHR glass are present in the form of silver-alkali-halide (AgX)ₘ(MX)ₙ complex nano crystals or nanophases that are about 10 nanometers (i.e. 100 Å) or less in each dimension within the cavity of the SiO₄ tetrahedron silicate glass network, wherein M represents an alkali ion, and X represents a halide such as chloride. The water species that is present in the glass network and/or is present in the interphase between the silver halide containing nanocrystals/nanophases and the silicate glass matrix and/or is present as an impurity in the silver halide containing nanocrystals/nanophases, is believed to function as electron traps or hole traps in various photo-reactions of the nanocrystals/nanophases discussed herein.

In general, an alkali silicate glass containing no other cations such as Zn⁺⁺ in the base glass composition may either crystallize or dissolve in the aqueous ion-exchange solution when soaked in the aqueous solution at the ion-exchange temperatures described herein for a certain amount of time. Therefore, each of the glass compositions of Table 1 contains a suitable concentration of an acid-durability-and-glass-networks-strengthener (ADAGNS) selected from ZnO, Al₂O₃, ZrO₂, TiO₂, and PbO or a mixture thereof, in order to ensure that the SIHR glass contains a uniform and desirable concentration of water species in the glass network of the silver ion rich SIHR glass. The base glass composition of a SIHR glass has a concentration of ADAGNS effective to render the SIHR glass free of any thermoplastic properties that may adversely affect the dimensional stability of the photosensitive glass layer for multiplex recording or reproduction of information utilizing holography. A particularly effective ADAGNS is ZnO. The base glass composition of a SIHR glass article preferably contains at least about 4% ZnO on the mole percent oxide basis.

Exemplary glass compositions 1 and 2 of Table 1 were ion-exchanged at 300° C. for six hours in an aqueous solution containing 200 g AgNO₃+36.7 cc of 16N HNO₃/liter of the solution to produce PDR glass plates No. 1A and No. 2A respectively. The thickness of the photosensitive glass layer, that is, the ion-exchanged surface glass layer of the PDR glass plates No. 1A and No. 2A was 80.5 and 79.4 micrometers respectively. Both plates No. 1A and 2A are clear glass plates, and are colorless and retain the optical quality surface and the bulk index homogeneity of the base anhydrous glass plates. It is herein defined that “clear” glass plate means, when examined under intense light illumination, for example, from a slide-projection lamp in a dark room, the glass plate is clear and transparent just like a high quality optical glass and there is no observable haziness indicating no scatter centers of any size larger than about 10 nanometer. PDR glass plates contain a high concentration of silver ions present in the form of AgCl containing complex nanocrystals/nanophases that are less than about 10 nanometers in each dimension and do not scatter light in the uv and visible spectral range.

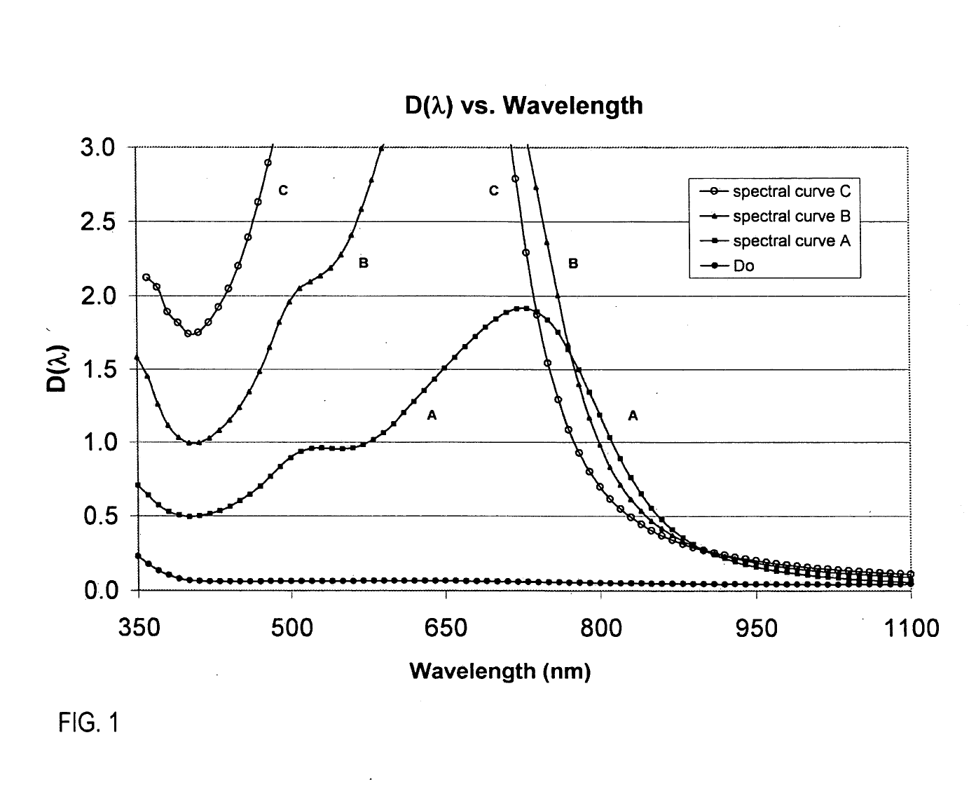

The optical density spectra Dₒ(λ) of PDR glass plate No. 1A having two ion-exchanged surface glass layers, that is, having two photosensitive glass layers of SIHR glass corresponding to two surfaces of a glass plate, are shown as spectral curve Do in FIG. 1. The subscript of Do represents zero exposure dosage to darkening-light radiation. The increasing Dₒ(λ) value at wavelengths below 400 nm is due to an Ag⁺ ion absorption band that peaks in a deep UV spectral range.

When SIHR glass was formed by silver ion-exchange of a base glass composition in an acidic aqueous solution, H⁺and/or H₃O⁺ ions entered into the glass network and silanol groups formed in the glass network. The formation of the silanol groups in a silicate glass is referred to as hydration of glass. SIHR glass was hydrated and a moving boundary type concentration profile formed; namely, the error function type concentration profile, which commonly exists as a result of a diffusion process, does not exist in a photosensitive glass layer of the SIHR glass. When water species are among the diffusing species in glass, the diffusion of water species (i.e. H⁺ and/or H₃O⁺) and Ag⁺ ions through a hydrated layer is accompanied by an instantaneous and irreversible immobilization of the diffusing species at the boundary surface. The moving boundary type diffusion profile of Ag⁺ in a photosensitive glass layer of the SIHR glass is characterized by an essentially constant concentration of Ag⁺ ions throughout the thickness dimension of the photosensitive glass layer. The Ag⁺ ions in the SIHR glass have a constant concentration profile along the depth dimension of diffusion because the diffusion coefficient of Ag⁺ ions in the hydrated glass layer is orders of magnitude larger than that in the anhydrous base glass.

The concentration of Ag⁺ ions is essentially constant throughout the thickness dimension of the photosensitive glass layer, and the thickness of the photosensitive glass layer is readily measured by observing the boundary line between the SIHR glass and the anhydrous base glass in the cross section of a PDR glass plate under a microscope. The Dₒ value of FIG. 1 at any one wavelength shorter than about 400 nm, for example, at 350 nm, was utilized to measure the relative concentration of Ag⁺ ions among various PDR glass plate samples. The optical density values and the corresponding % T in parenthesis of plate No. 1A along the Dₒ(λ) spectral curve of FIG. 1 are 0.230 (58.9% T) and 0.063 (86.5% T) at 350 nm and 400 nm wavelengths respectively.

### Photo Energy Darkening Mode of Recording in a PDR Glass Plate and Reproduction of Information Light

PDR glass plates were darkened through exposure to a darkening-light radiation without any post-exposure development or fixing step. Wavelengths of practical and readily available darkening-light sources include 254 nm, 365 nm, 405 nm, 436 nm, and 442 nm. In plate 1A, the observed darkening-light radiation exposure induced optical density spectra D(λ), see spectral curves A, B, and C of FIG. 1, which are interpreted as a manifestation of two distinct atomic silver cluster species that co-exist with silver ions Ag⁺ in the SIHR glass, and that both silver cluster species existing upon exposure to darkening-light radiation of any desired dosage levels are stable in the SIHR glass.

In general, either one of the two atomic silver cluster species may be dominant in concentration in a SIHR glass of different glass compositions. Elementary silver atoms and/or clusters of silver atoms are formed within or on the surface of the silver-alkali-halide containing or silver chloride containing complex nanocrystals/nanophases during exposure of SIHR glass to darkening-light radiation, at exposure temperatures that are, in general, at or near room temperatures. The formation of these atomic silver cluster species is believed to involve a movement of electrons, such as delocalization of electrons among a group of silver atoms, and that there is likely to be no diffusion of silver ions or silver atoms as a result of the exposure at or near room temperatures to the darkening-light radiation.

The broad absorption bands in D(λ) spectra of PDR glass plates are absorption bands of atomic silver species in various stable states of coagulation. Since the coagulation of silver atoms are due only to delocalization of electrons, it is possible that two distinct silver species in a SIHR glass are monoatomic species of silver color centers in which an electron is delocalized due to a static force field surrounding a silver atom, and polyatomic silver clusters consisting of two or more silver atoms. Because the monoatomic silver color centers and the polyatomic silver clusters are of molecular dimensions, they do not scatter light in the visible and UV spectral ranges.

SIHR glass has a uniform refractive index and does not scatter light propagating therethrough before and after being darkened with darkening-light radiation selected from the UV, blue light, and longer wavelengths. The absorption bands in D(λ) spectra of SIHR glasses are due to excitation of transition dipoles of delocalized electrons of elementary silver atoms and/or clusters of silver atoms, and there exists no attenuation of light due to scattering.

Portions of PDR plate No. 1A were exposed to darkening-light radiation at the mercury I line at 365 nm wavelength at an intensity level of 23.18 mw/cm². The optical density spectra D(λ) of darkened areas that have been exposed to 2.51 joule/cm², 10.9 joule/cm² and 78 joule/cm² of light radiation at 365 nm are represented by curves A, B, and C of FIG. 1. The optical density spectra D(λ) represented by curve A has a dominant absorption band peaked at 730 nm wavelength, and the peak optical density value Dₚ at the wavelength of the absorption peak λₚ is 1.91; namely Dₚ=1.91 at the λₚ value of 730 nm, corresponding to an exposure dosage of 2.51 joule/cm². The Dₚ value of curve B and curve C are beyond the measurable range of the Hitachi U2000 spectrophotometer that was employed for the measurements of D(λ).

As shown in FIG. 1, there exist two darkening-light radiation exposure induced absorption bands. It has been determined that the relative strength as well as the peak wavelengths λₚ's of these absorption bands depend on the base glass composition and on the variable parameters of the ion-exchange process, including in particular the concentration of Ag⁺ and H⁺ ions in the aqueous ion-exchange solution, as well as on the temperature and duration of the ion-exchange process. The peak wavelengths of these two absorption bands are referred to herein as λₚ₁ and λₚ₂. It also has been determined that λₚ₁ of a SIHR glass may be at any one wavelength ranging from about 445 nm to about 650 nm, and that λₚ₂ of a SIHR glass may be at any one wavelength ranging from about 580 to about 850 nm. The absorption band centered at λₚ₂ is the dominant absorption band in the 365 nm (darkening-light radiation) exposure-induced absorption spectra of the PDR glass plate No. 1A. Dₚ increases with the exposure dosage of the darkening-light radiation, as seen in FIG. 1. Also shown in FIG. 1, as Dₚ increases, λₚ₂ decreases. As a consequence of the blue-shifting λₚ₂, the optical density values of PDR plate No. 1A at longer wavelengths, for example at 900 nm, are more or less independent of the growth of Dₚ with exposure dosage. This property (see FIG. 1), that is, the optical density D(λ), at a wavelengths of longer than about 900 nm is more or less independent of the dosage of darkening-light exposure, provides an advantageous property of the SIHR glass for use in volume multiplexing of holographic recording and read back, without excessive absorption losses at a read wavelength.

Dₚ (curve C of FIG. 1) reaches a very large value of more than 6, nevertheless, a sufficiently low value of optical density (OD) exists in the D(λ) spectra of curve C at a selected wavelength of a laser read beam for multiplex reproduction of information light utilizing holography. For example, OD values of 0.861, 0.490, 0.271, 0.157 and 0.110 are found in curve C of FIG. 1 at candidate read wavelengths of 785 nm, 830 nm, 900 nm, 1000 nm and 1100 nm respectively.

The transmittance at read wavelengths can be further increased by selecting a SIHR glass that has a darkening-light exposure induced absorption band at shorter wavelengths.

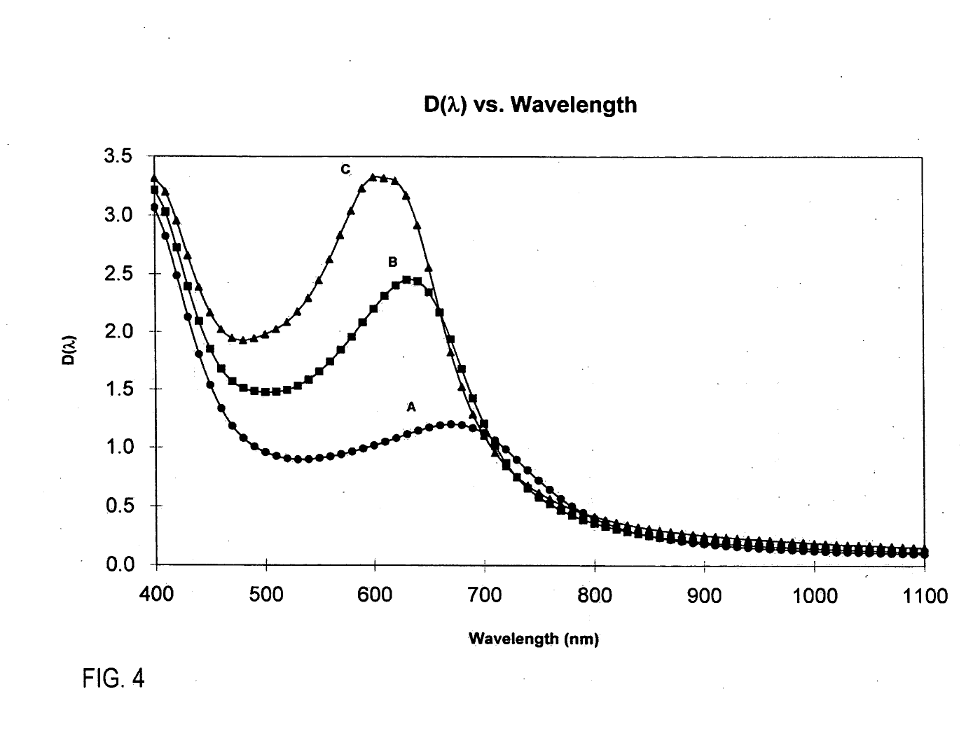

The high absorption losses at read wavelengths, which are usually observed in prior art photochromic films and which limit their useful sample thickness, are circumvented in PDR as well as PBR glass plates because of blue shifting λₚ with increasing exposure dosage of darkening light radiation for selected compositions of SIHR glasses. This phenomenon, shown in FIGS. 1 and 4, is further elaborated in a later section.

### Increases in the Sensitivity of SIHR Glass to Darkening-Light Radiation With the Addition of MgO as a Batch Ingredient in a Base Glass Composition

Certain chemical elements added in the glass melt batch of the parent/base glass composition of a SIHR glass can cause the silver ion-exchanged PDR glass plates to become more sensitive to darkening-light radiation, requiring a lesser exposure dosage to produce a desired darkening-light radiation exposure induced optical density in a PDR glass article, and/or to become sensitive to darkening-light radiation of longer wavelengths. A particularly effective chemical element for increasing the sensitivity to darkening-light exposure of the silver chloride containing nanocrystals/nanophases is magnesium, i.e. MgO in the parent/base glass melt batch.

When MgO was added to the glass melt batch of a base glass composition of a PDR glass article, the darkening light exposure-induced optical density, as well as the accompanying change in refractive index, increased exceptionally. Namely, the sensitivity of a SIHR glass to darkening mode of recording of information light utilizing holography increases with the addition of MgO as a batch ingredient in the glass melt batch.

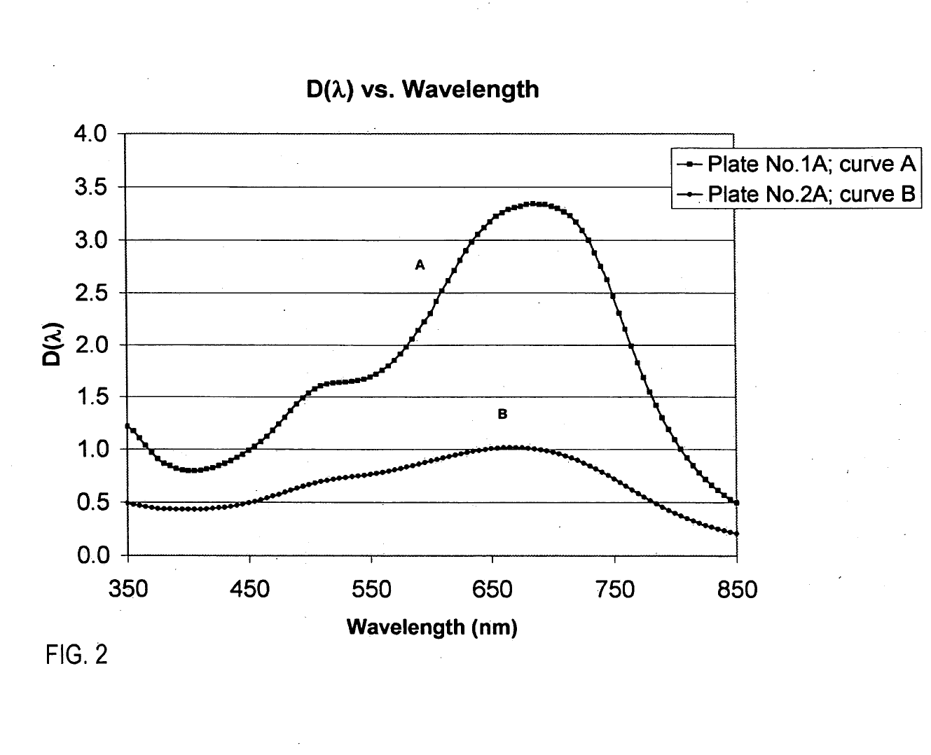

Curves A and B of FIG. 2 depict the optical density spectra D(λ) of PDR glass plates No. 1A and No. 2A respectively after identical exposure to 5.0 joule/cm² of darkening-light radiation at 365 nm. Glass composition No. 1 of Table 1 is derived from an addition of 2.9 mole % MgO in the glass melt batch of glass composition No. 2 of Table 1. In going from curve B to curve A of FIG. 2, it is apparent that the optical density value Dₚ increases by a factor of more than 3 at the spectral absorption peak due to the addition of 2.9 mole % MgO in base glass composition No. 2. The magnitude of the advantageous effects of enhancing the sensitivity and of increasing the dynamic range of darkening light radiation exposure-induced optical density in SIHR glass depends on the base glass composition, and can be maximized by optimizing the MgO concentration for the specific glass composition. In general, the optimum concentration of MgO occurs within a range of about 2% to about 12% MgO on a mole percent oxide basis in the base glass compositions.

### Dynamic Range of Index Modulation Δn in a PDR Glass Plate

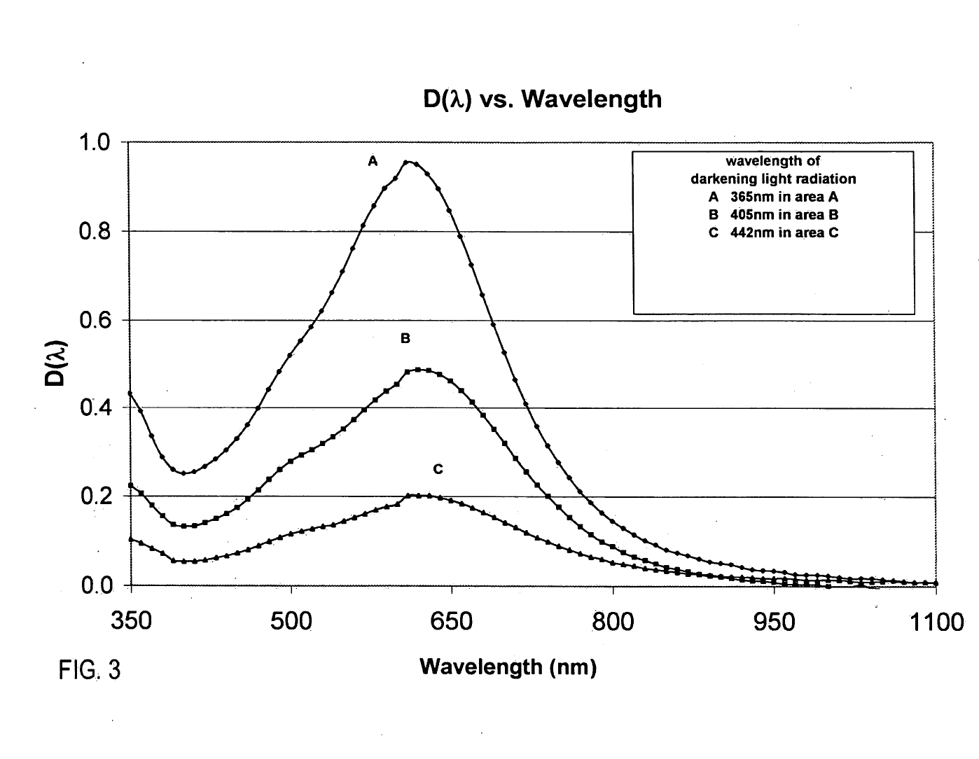

Glass composition No. 18 of Table 1, containing 5.26 mole percent of MgO, was ion-exchanged at 310° C. for 50 minutes to produce a 10 μm photosensitive glass layer of PDR glass plate No. 18A. Plate No. 18A, having a SIHR glass layer of 10 μm, was exposed in three areas A, B, and C to an exposure dosage of 10 joule/cm² with darkening-light radiation having wavelengths of 365 nm, 405 nm, and 442 nm respectively. The optical density spectra D(λ) of the exposure darkened area A, area B, and area C of plate No. 18A are exhibited FIG. 3. As shown in FIG. 3, the values of peak optical density Dₚ are 0.954, 0.486, and 0.201 in areas A, B, and C respectively, and the wavelength λₚ of the absorption peak remains at about 620 nm in areas A, B, and C of plate No. 18A.

The darkening-light radiation at 365 nm, at 405 nm, or at 442 nm may be used as write beams to record holograms in the photosensitive glass layer of the SIHR plate. It is shown below that the read wavelength for holographic reconstruction is preferably at a wavelength longer than about 750 nm, for example, 785 nm, or 830 nm, or 900 nm.

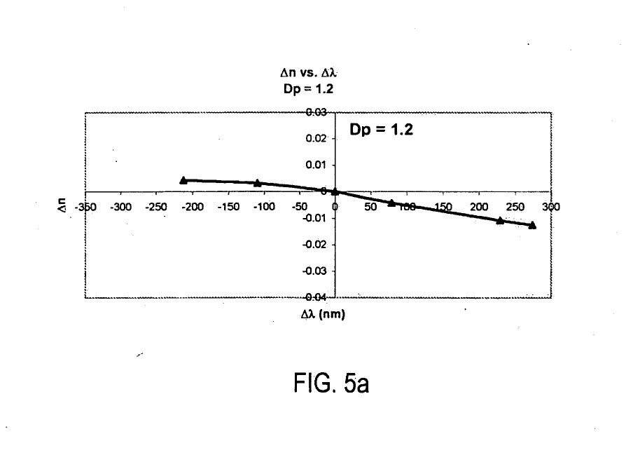

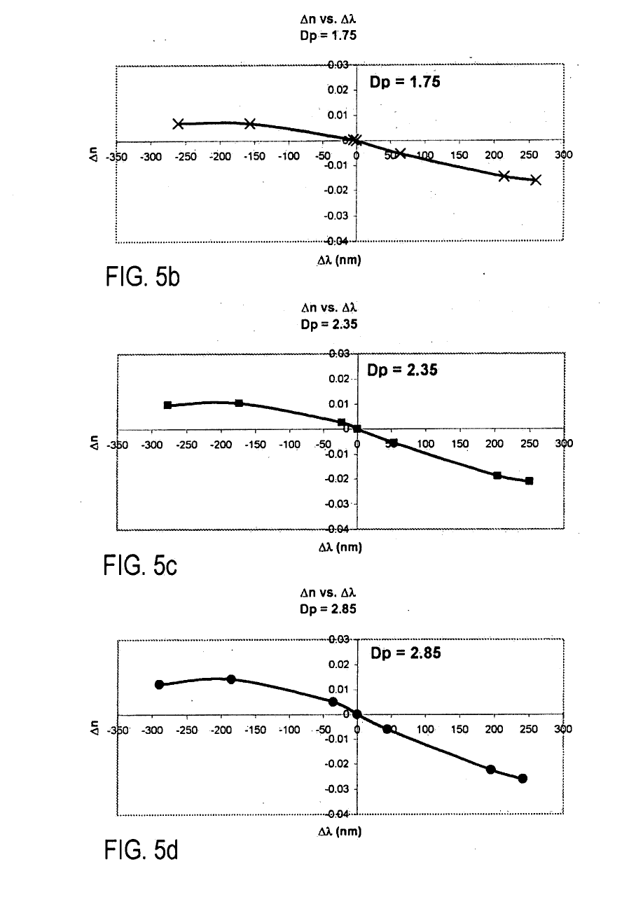

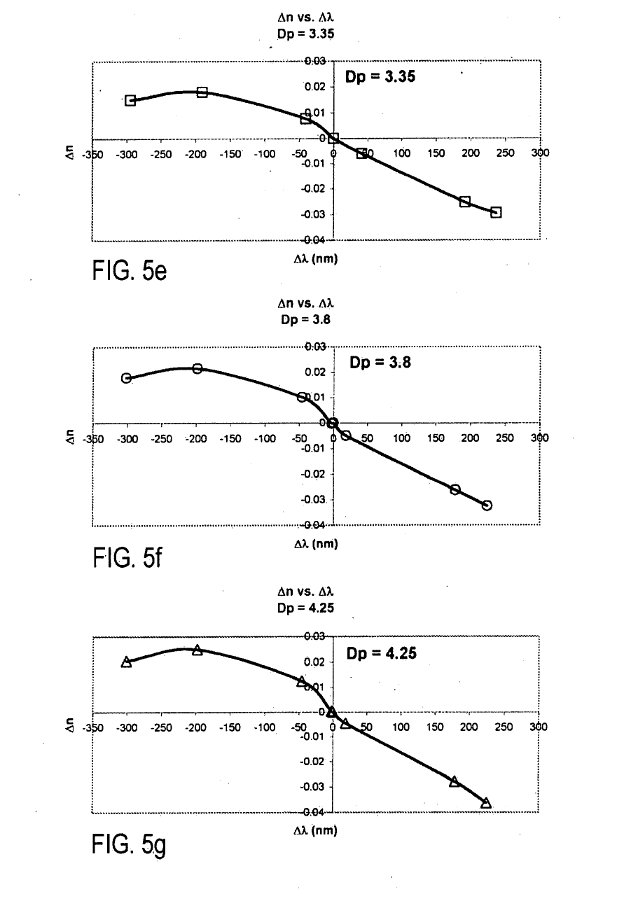

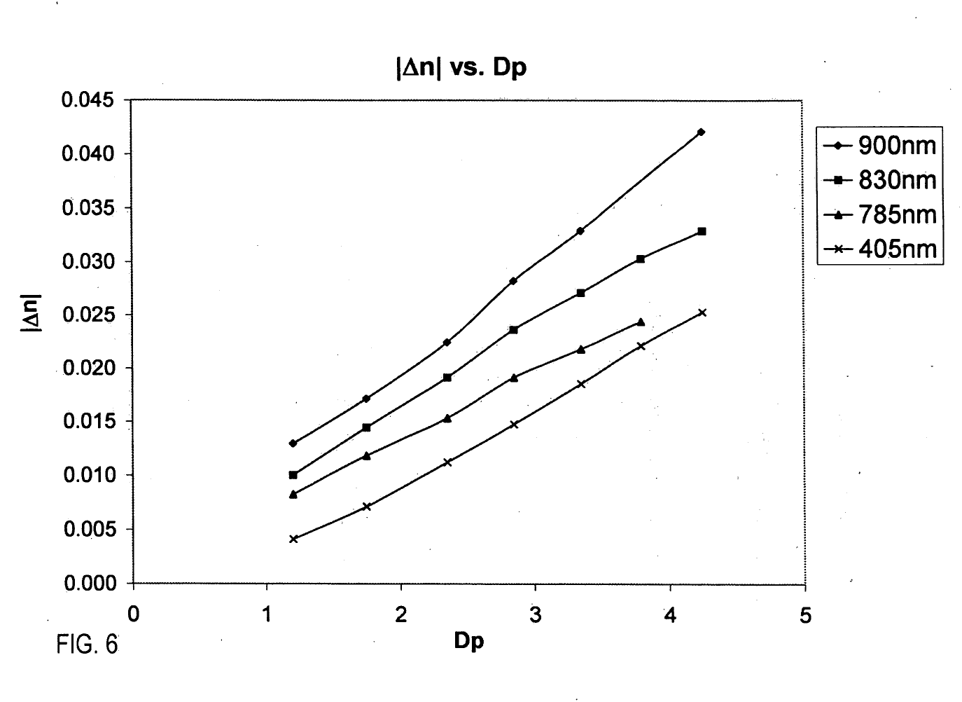

Δn(λ, Dₚ) of SIHR glasses due to exposure-induced change in the oxidation state of silver from silver ions to clusters of elementary silver atoms is discussed in the section “Δn between Darkened and Undarkened Areas.” FIGS. 5a-5g depict Δn(λ, Dₚ) vs. λ having the optical density value at the absorption peak Dp as a variable parameter. FIG. 6 depicts Δn(λ, Dₚ) vs. Dₚ having the wavelength λ as a variable parameter.

The darkening-light exposure-induced changes in refractive index |Δn| at 785 nm read-wavelength for each of the three areas A, B, and C of plate No. 18A are 6.73×10⁻³, 3.65×10⁻³, or 2.11×10⁻³ respectively. These values of |Δn| at 785 nm are readily found from the |Δn| vs. Dₚ plot of FIG. 6 by reading the |Δn| values corresponding to Dₚ values of 0.954, 0.486, and 0.201 respectively along the curve labeled 785 nm. Also derived from FIG. 6, the index changes |Δn| at 830 nm (another candidate read-wavelength) are 7.31×10⁻³, 4.42×10⁻³, and 1.88×10⁻³ in the darkened areas A, B, and C, respectively, while the index changes |Δn| at 900 nm are 1.1×10⁻², 7.31×10⁻³, and 5.0×10⁻³ in the darkened areas A, B, and C, respectively.

The dynamic range, that is, the refractive index change, Δn of e.g. 1.1×10⁻² at a read beam wavelength indicates that a large number of high efficiency holograms can be recorded in the same volume of a SIHR glass layer. Preferably, the thickness of the SIHR glass layer is more than about 10 μm, e.g. 50 to 200 μm. When a number of holograms are recorded in a 100 μm thickness of SIHR glass of base glass composition 18 with the sum of the multiplexed hologram recording dosage of 10 Joule/cm² at 365 nm write wavelength, the Dₚ value resulting from the multiplexed hologram recording with darkening write beams is expected to be about 9.54. As is further elaborated in the paragraphs below, such a large value of Dₚ is acceptable in holographic reconstruction, provided the wavelength of the read beam is so chosen that the optical density at read wavelength is sufficiently low, e.g., less than 1.0 and preferably less than 0.3. Since a refractive index change of 10⁻⁵ at a read wavelength is adequate for holographic reconstruction, the minimum write dosage of darkening-light radiation to form one volume phase hologram in a PDR glass plate is about 10 to 100 mJ/cm².

### Advantageous Effects of Blue Shifting λₚ by Accumulated Darkening Light Exposures in Multiplexed Hologram Recording

Glass composition No. 3 of Table 1 was ion-exchanged at 260° C. for 6 hours to produce PDR glass plate No. 3A having a photosensitive glass layer of 130 μm thickness. Plate No. 3A was exposed in 3 areas A, B, and C to a dosage of 4, 20, and 60 Joule/cm² respectively with darkening-light radiation at 365 nm wavelength. The optical density spectra D(λ) of the exposure darkened areas A, B, and C are exhibited in FIG. 4 as spectral curves A, B, and C respectively. As shown in the spectral curves A, B, and C of FIG. 4, the wavelength of absorption peaks are 670 nm, 630 nm, and 600 nm respectively. As the exposure dosage of darkening-light radiation at 365 nm increased from 4 joule/cm² to 20 joule/cm² and to 60 joule/cm², the wavelength of the absorption peak λₚ blue shifted from 670 nm of spectral curve A to 630 nm of spectral curve B and to 600 nm of spectral curve C. As a consequence of the advantageous effect of blue shifting λₚ, the optical density values D(λ) at a wavelengths longer than 780 nm is nearly independent of the exposure dosage of the darkening-light radiation, and is therefore nearly independent of Dₚ values. Namely, D(λ) values at wavelengths longer than 780 nm remain essentially constant at low values as the total of accumulated exposure dosage of recording multiple holograms within the same volume of a SIHR glass layer is increased.

As shown in the spectral curves of FIG. 4, when the total of the accumulated write dosage of holographic multiplexing in PDR plate 3A increases from that of spectral curve A to curve B and to curve C, the optical density value D(785 nm) at a read wavelength of 785 nm reduces from 0.501 of spectral curve A to 0.425 of spectral curve B and to 0.477 of spectral curve C, while the optical density value D(830 nm) at a read wavelength of 830 nm remains nearly constant at 0.399 of spectral curve A, 0.358 of curve B, and 0.413 of curve C, and the optical density D(900 nm) at a read wavelength of 900 nm remains little changed at 0.186 of spectral curve A, 0.200 of curve B, and 0.257 of curve C, despite a greatly increased Dₚ value from 1.20 of spectral curve A to 2.54 of spectral curve B and to 3.22 of spectral curve C. More Advantageous Properties of SIHR Glasses As a Holographic Storage Medium

Scattering noise in holographic reconstruction due to bulk inhomogeneity is a serious disadvantage of many prior art holographic recording materials. Nevertheless, SIHR glasses are silicate glasses and can be mass produced in very good optical quality using conventional optical glass melting processes. Due to a very low noise in holographic reconstruction, a large value of signal to noise ratio can be expected, and the required index change between 1 bit and 0 bit within a digital hologram is less than about 10⁻⁵. A digital hologram having index modulation of 10⁻⁵ can be produced in a PDR glass plate using an exposure dosage of more than about 10 millijoule/cm² at a write beam wavelength of 365 nm, or about 30 mJ/cm² at a write wavelength of 405 nm.

Areas of PDR glass plate No. 1A represented by spectral curves D₀, A, B, and C of FIG. 1 and by spectral curve A of FIG. 2, and areas of PDR glass plate No. 2A represented by spectral curve B of FIG. 2, as well as areas of PDR glass plate No. 3A represented by spectral curves A, B, and C of FIG. 4, are permanently stable in room lighting conditions and in ambient atmospheric conditions at zero to 100% humidity levels. In the absence of the darkening-light radiation, the clear and colorless areas of an unexposed PDR glass plate remain clear and colorless essentially permanently, yet the sensitivity to darkening-light radiation is constant essentially permanently.

### Δn Between Darkened and Undarkened Areas

HEBS-glasses are High Energy Beam Sensitive glasses, as disclosed in U.S. Pat. Nos. 4,670,366 and 5,078,771 to Wu, the contents of which are incorporated herein by reference. A HEBS-glass plate is a silver ion-exchanged glass plate that is sensitive to electron beams with more than about 10 KeV of kinetic energy and that is inert to light radiation of UV, visible and longer wavelengths. Silver halide containing nanocrystals/nanophases in HEBS-glasses are sensitive to and darkenable with high energy electron beams having kinetic energy of more than about 10 KeV, and are insensitive to UV light and longer wavelength, because a large energy band gap exists between the valence band and the conduction band of the silver halide containing nanocrystals/nanophases in a silicate glass matrix of HEBS-glass compositions. On the other hand, the silver halide containing nanocrystals/nanophases in a silicate glass matrix of SIHR glasses have a small energy band gap between their valence band and conduction band, therefore, SIHR glasses are sensitive to and darkenable with UV light and longer wavelength. The energy band gap of silver halide containing nanocrystals/nanophases in a HEBS-glass is increased by the addition of a transition metal oxide, TiO₂ in particular in the base glass composition of HEBS-glasses, as discussed in the '366 patent. On the other hand, the energy band gap of silver halide containing nanocrystals/nanophases in SIHR glasses is decreased by the addition of MgO in the base glass composition of SIHR glasses.

The darkening radiation exposure-induced spectral absorption bands in both a HEBS-glass plate and a PDR glass plate are caused by elementary silver atoms and/or clusters of silver atoms. This is expected to cause an accompanying increase or change in the refractive index Δn(λ) in the exposure darkened area. According to the Kramers Kronig dispersion relationship, the accompanying index change Δn(λ) is dependent primarily on the strength of the absorption band per unit thickness of a HEBS-glass or a SIHR glass and is independent of whether the darkening radiation is a light radiation or an electron beam. Exposure-induced Δn(λ) value due to a change in the oxidation state of silver from silver ions to clusters of elementary silver atoms is calculated from measured data of phase advance in a HEBS-glass plate. The calculated dispersion spectra Δn(λ) corresponding to an exposure-darkened level, which is defined by a Dₚ value of a HEBS-glass plate, is applicable qualitatively to SIHR glasses for the purpose of estimating the Δn(λ, Dₚ) values discussed herein.

FIGS. 5a-5g show the difference in refractive index Δn between darkened and undarkened areas of a silver ion-exchanged glass that includes SIHR glasses and HEBS-glasses, as a function of Δλ, wherein Δλ=λ−λₚ. The peak optical density value Dₚ of an e-beam exposure-darkened area having a silver ion-exchanged surface glass layer of 10 micrometer thickness is a variable parameter in FIGS. 5a-5g.

The graphical representation Δn(λ, Dₚ) vs. Δλ of FIG. 5 depicts the change in refractive index of the silver ion-exchanged glass containing silver halide complex nanocrystals/nanophases. Δn(λ, Dₚ) arose from exposure induced change in the oxidation state of silver from silver ions to clusters of elementary silver atoms, in other words, Δn(λ, Dₚ) is originated from a change of electron density in silver halide nanocrystals/nanophases containing glasses due to the creation of monoatomic silver species and polyatomic silver cluster species, the sum concentration of which is qualitatively defined by a Dₚ value.

FIGS. 5a-5g were calculated from wavefront phase advance of an e-beam darkened HEBES-glass plate having a silver ion-exchanged surface glass layer of 10 μm thickness. The wavefront phase advance was measured by an interferometric method, see for example, “Measurement of wavefront phase delay and optical density in apodized coronographic mask materials” by Peter G. Halverson et. al in Technique and Instrumentation for Detection of Exoplanets II, edited by Danien R. Coulter, Proceedings of SPIE Vol. 5905.

FIGS. 5a-5g are utilized herein to predict qualitatively the change in refractive index of a SIHR glass which has been exposed to darkening-light radiation to result in exposure induced optical density spectra having Dₚ values found in FIGS. 5a-5g.

In FIGS. 5a-5g, Δn between darkened and undarkened areas is plotted as a function of Δλ; where Δλ=λ−λₚ; or λ=Δλ+λₚ, with Dₚ being a variable parameter among the plots of FIGS. 5a-5g. Dₚ and λₚ are characteristic properties of a darkened SIHR glass and are found in the measured absorption spectra of the exposure darkened SIHR glass.

FIGS. 5a-5g are utilized to predict |Δn| values at holographic write or read wavelengths of a SIHR glass layer whose absorption spectra have been measured. The |Δn| value at any chosen wavelength of a SIHR glass having a Dₚ value of 1.2, 1.75, 2.35, 2.85, 3.35, 3.38 and 4.25 per 10 μm thickness of the SIHR glass layer is readily found in FIGS. 5a, 5b, 5c, 5d, 5e, 5f, and 5g respectively. As shown below, the |Δn| values at hologram recording or reconstruction wavelengths of e.g. 405 nm, 785 nm, 830 nm, and 900 nm can be derived for SIHR glasses whose Dₚ and λₚ values have been measured from the absorption spectra of a PDR glass plate.

For example, by setting λₚ=620 nm, Δn values of plate No. 18A at wavelengths of 405 nm, 785 nm, 830 nm, and 900 nm are found in FIGS. 5a-5g to corresponds to Δλ values of −215 nm (=405 nm−620 nm), 165 nm (=785 nm−620 nm), 210 nm (=830 nm−620 nm) and 280 nm (=900 nm−620 nm) respectively. |Δn| values of plate 18A having a λₚ value of 620 nm are plotted as a function of Dₚ values in FIG. 6, where the read wavelengths (for example, 785 nm, 830 nm, and 900 nm) or write wavelengths (e.g. 405 nm) are shown as a variable parameter. FIG. 6 depicts the darkening-light exposure induced change in refractive index |Δn| that is, |Δn(λ, Dₚ)| vs. Dₚ values per 10 μm thickness of a PDR glass plate, for example, plate No. 18A having a λₚ value of 620 nm.

It is shown in FIG. 6 that the |n| value of plate 18A increases with the value of Dₚ pre SIHR glass layer thickness of 10 μm, and also increases with a longer read-wavelength or with a larger value of λ−λₚ. At any selected hologram recording or reconstruction wavelength, the |Δn| values of a PDR glass plate may be found in FIG. 5 for given values of Dₚ and λₚ. For example, the |Δn| values of a SIHR glass layer having a Dₚ value per 10 μm thickness of 1.2 and a λp value of 620 nm are 0.00823, 0.010, and 0.0129 at wavelengths of 785 nm, 830 nm, and 900 nm respectively, and the |Δn| values of a SIHR glass layer having a Dₚ value per 10 μm thickness of 3.35, and a 4 value of 620 nm, are 0.0218, 0.0271, and 0.0329 at wavelengths 785 nm, 830 nm, and 900 nm respectively.

### Δ(Δn); Change in Δn Arising from λₚ Being Shifted by a Bleaching Write Beam

The absorption band of pre-darkened SIHR glass was found to shift along the wavelength coordinate, when a uniformly darkened area of a pre-darkened SIHR glass layer was bleached with a bleaching-light radiation. For example, when a pre-darkened SIHR glass layer of a PBR glass plate was bleached with a red light laser beam, λₚ of the PBR glass plate was shifted from 700 nm to 520 nm.

The change in refractive index Δn between unexposed area and exposure-darkened areas differs as λₚ is shifted from e.g. 700 nm to 520 nm. The change in Δn value at a given wavelength, arising from λₚ being shifted e.g. from 700 nm to 520 nm upon laser light bleaching, is referred to herein as Δ(Δn). Example of Δ(Δn) values are discussed immediately below.

Referring to FIG. 5a, by setting λₚ=700 nm, Δn values of pre-darkened SIHR glass having a Dₚ value of 1.2 and λₚ value of 700 nm are found to be +0.00235, (−0.00441), and (−0.00647) at wavelengths of 633 nm, 785 nm, and 830 nm, respectively.

By setting λₚ=520 nm in FIG. 5a, Δn values of pre-darkened SIHR glass having a Dₚ value of 1.2 and having been bleached to shift λₚ to 520 nm (from 700 nm) are found to be (−0.00588), (−0.01235), and (−0.01412) at wavelengths of 633 nm, 785 nm, and 830 nm respectively. Δ(Δn) values arising from λₚ being shifted from 700 nm to 520 nm are calculated immediately below; with a Δ(Δn) value as the difference in Δn value of a PBR glass plate before and after being bleached with a bleaching-light radiation.

The Δ(Δn) value at 633 nm is equal to 0.00823, which is 0.00235−(−0.00588). The Δ(Δn) value at 785 nm is equal to 0.00794, which is (−0.00441)−(−0.01235). The Δ(Δn) value at 830 nm is equal to 0.00765 which is (−0.00647)−(−0.0142).

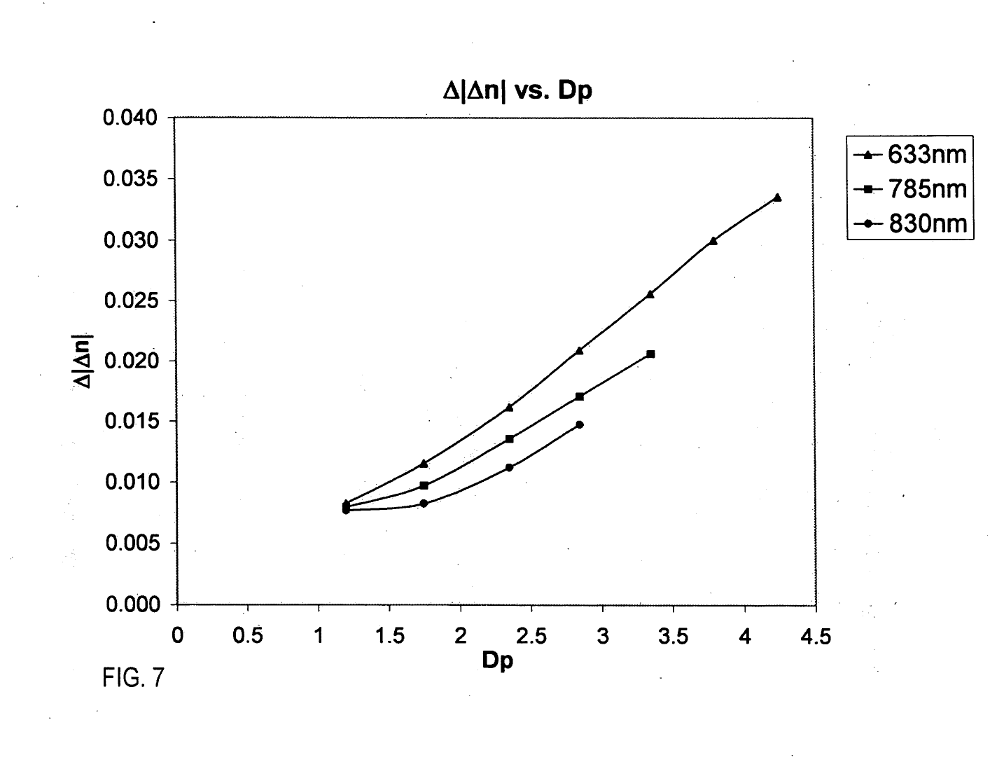

The Δ(Δn) values of a PBR glass plate having Dₚ values of 1.75, 2.35, 2.85, 3.35, 3.8 and 4.25 were derived from FIGS. 5b, 5c, 5d, 5e, 5f, and 5g respectively at read wavelengths of 633 nm, 785 nm, and 830 nm. The calculated Δ(Δn) values at chosen wavelengths, for example, 633 nm, 785 nm, and 830 nm, arising from λₚ being shifted from 700 nm to 520 nm are represented in FIG. 7, in which the Δ(Δn) value of a PBR glass plate is plotted as a function of Dₚ, and the read wavelengths are shown as the variable parameter.

### Photo Energy Bleaching Mode of Holographic Recording in A PBR Glass Plate: Photoadaptation and Spectral Hole Burning in Uniformly Darkened SIHR Glasses

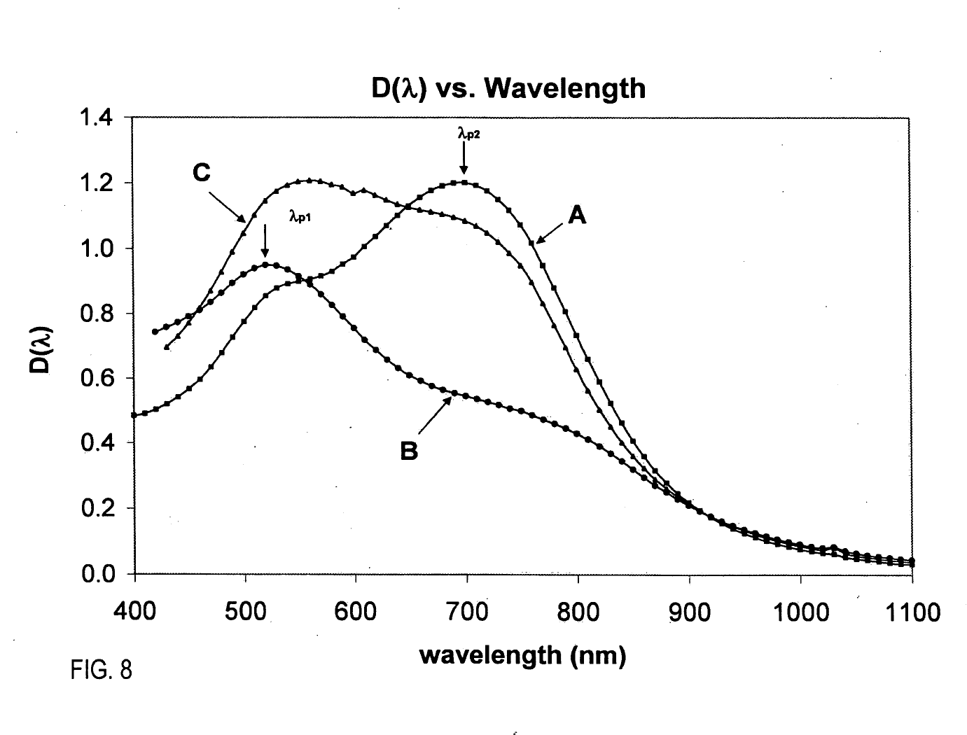

One or more types of silver clusters were formed in the pre-darkened SIHR glass layer of a PBR glass plate. The darkening-light radiation of SIHR glasses includes light radiation having wavelengths selected from ultraviolet, blue light and green light. It is postulated herein that the absorption bands which peaked at λₚ₁ and λₚ₂ (see FIG. 8) are due to plasmon resonance absorption of type 1 and type 2 silver clusters, respectively. The silver clusters whose plasmon resonance absorption frequencies are excited by bleaching-light radiation energy of a write beam are ionized, and the photo-excitation causes electrons of the silver clusters to go into the conduction band of silver halides (silver chloride in particular) containing nanocrystals/nanophases. The photo induced dissolution of silver clusters is observed, and is evidenced by a reduction of absorption strength in a wavelength range which may span a portion of the wavelength range of an absorption band, for example, the λₚ₂ band being bleached. This phenomenon is referred to herein as spectral hole burning.

It was observed that the spectral hole burning of one of the absorption bands, e.g. the λₚ₂ band may be accompanied by a spectral growth of other absorption bands, for example, the λₚ₁ band and vice versa. This phenomenon is herein referred to as photo-adaptation.

The bleaching-light radiation which is most effective in causing the spectral hole burning and/or photo-adaptation of a PBR glass plate is in the wavelength range of red light including, among others, 633 nm of a HeNe laser, 647 nm from an ArKr mixed gas laser, and 650 nm of a diode laser, and may also include green light. It has also been observed that when a photosensitive glass layer of a PBR glass plate, that is, a layer uniformly darkened to, for example, blue colored SIHR glass, is bleached with a red light laser, the area exposed to the red laser light turns red in color instantaneously, and without any post exposure processing step, and that when the red colored area is later bleached with a green light laser, the area exposed to the green laser light turns green in color instantaneously. The green colored area is reversed to red color when it is later bleached with a red light laser. Blue, red, and green colored areas in a PBR glass plate are permanently stable in room lighting conditions.

Glass composition No. 8 of Table 1 was ion-exchanged at 340° C. for 4 hours to produce an ion-exchanged glass plate No 8A that is colorless and clear and that has a SIHR glass layer of 78 μm thickness. Two areas (each being 0.25″×2″) of plate No. 8A was uniformly darkened with UV 365 nm darkening-light radiation from Spectroline Black-Ray Lamp Model B-100 at an intensity level of 7 mW/cm² for 20 and 10 minutes to form PBR glass plate 8A-light blue area and PBR plate 8A-lighter blue area respectively. These two UV darkened areas in the PBR glass plate 8A appear light blue and lighter blue in color and have a Dₚ value of 1.20 and 0.72 respectively. In other words, there are two photosensitive glass layers in the PBR glass plate 8A, one being the light blue area and the other being the lighter blue area. Curve A of FIG. 8 records the optical density spectra of the light blue area in PBR glass plate No. 8A. As shown in curve A of FIG. 8, the absorption peak-wavelengths of two plasmon absorption bands in the light blue area of the PBR glass plate 8A are λₚ₁ at 520 nm and λₚ₂ at 700 nm.

A portion of each of the light blue and the lighter blue areas was bleached with a 15 mW plane, polarized 633 nm, red laser beam having a beam cross section of 1.5 mm diameter from a HeNe laser. Red light bleached areas, each being 0.25″×0.5″, were produced by raster exposures of 5 second pulses of the plane polarized HeNe laser beam, 15 mWatt in a 1.5 mm diameter spot, at 0.34 mm grid spacing, on the light blue and the lighter blue areas of plate No. 8A. Both of the 0.25″×0.5″ areas that were exposed to red polarized red light turn into red colors. Light red and lighter red areas were produced from the original light blue and lighter blue areas of the photosensitive glass layers of the PBR plate respectively. The red colored areas so produced in plate No. 8A are plane polarized.

Curve B of FIG. 8 records the optical density spectra of the light red colored area using a probing beam that is plane-polarized in the parallel direction with respect to the polarization direction of the red bleached area. Curve C of FIG. 8 records the optical density spectra of the light red colored area using a probing beam that is plane polarized in the perpendicular direction with respect to the polarization direction of the red bleached area.

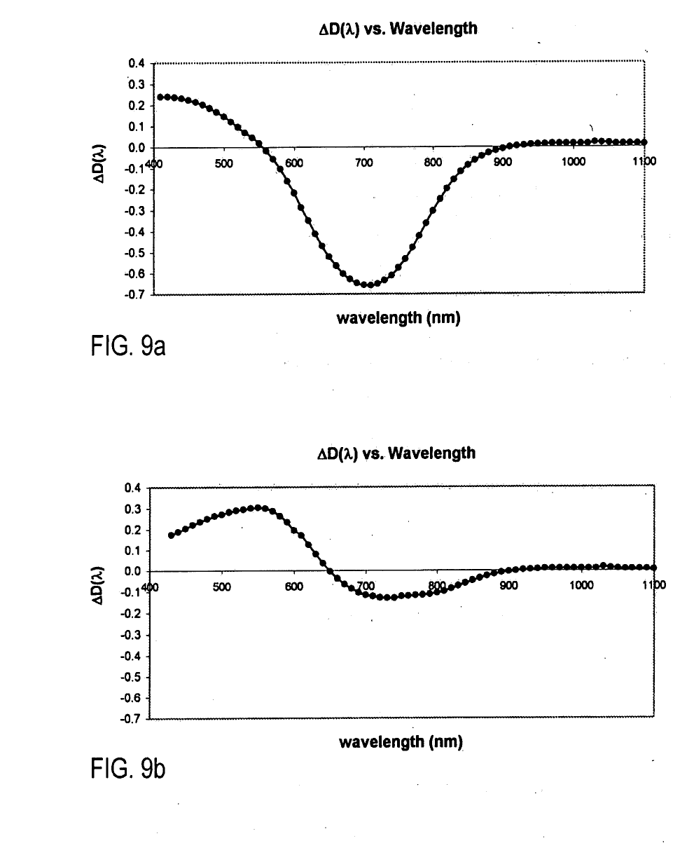

Examining the transformation of spectral curve A to curve B of FIG. 8, it is observed that the optical density spectrum of curve A is bleached in the parallel polarization direction in the wavelength range of 555 nm to 910 nm by the plane-polarized bleaching-light radiation at 633 nm wavelength, and that the maximum extent of bleaching occurs at or near the peak-wavelength λₚ₂ (at 700 nm) despite the wavelength of the beaching beam being 633 nm. This phenomenon is more clearly illustrated by the difference OD spectra ΔD(λ) shown in FIG. 9A, where the difference OD spectrum ΔD(λ)is D(λ) of spectral curve B minus D(λ) of spectral curve A. Negative values in the difference OD spectrum ΔD(λ) represent spectral hole burning and depict the amount of color centers, that is, silver clusters being bleached or being dissolved. The positive values in ΔD(λ) of FIG. 9A represent the amount of silver clusters having plasmon resonance frequencies outside the wavelength ranges of 555 nm to 910 nm that are created.

Because the polarizers used to polarize the probing beams in the measurement of spectral curves B and curve C of FIG. 8 do not function at wavelengths shorter than 400 nm, the spectral range of FIGS. 8 and 9 is limited to wavelengths longer than 400 nm. As a consequence, FIG. 9A exhibited only a portion (about 50%) of the amount of silver clusters being created.

Examining the transformation of spectral curve A to curve C of FIG. 8, it is observed that the optical density spectrum of curve A is bleached in the perpendicular polarization direction in the wavelength range of 650 nm to 910 nm by the plane polarized bleaching-light radiation at 633 nm wavelength. FIG. 9B displays the difference OD spectrum ΔD(λ), which is D(λ) of spectral curve C minus D(λ) of spectral curve A. It is shown that the maximum extent of bleaching in the perpendicular polarization occurs in the wavelength range near λₚ₂ (at 700 nm) despite the wavelength of the bleaching beam being 633 nm. The positive values in ΔD(λ) of FIG. 9B represent the amount of silver clusters having plasmon resonance frequencies outside the wavelength range of 650 nm to 910 nm that are created.

The sum of negative areas in the integrals ∫ΔD(λ)dλ contributed from negative values of ΔD(λ) in the spectral curves of FIGS. 9A and 9B combined represents the amount of silver cluster species being dissolved by the bleaching beam. On the other hand, the sum of positive areas in the integrals ∫ΔD(λ)dλ contributed from positive values of ΔD(λ) in the spectral curves of FIGS. 9A and 9B combined represents the amount of silver cluster species being created by the bleaching beam.

FIG. 9A depicts the amount of silver cluster species having a parallel polarization being dissolved, as well as the amount of silver cluster species having a parallel polarization being created. FIG. 9B depicts the amount of silver cluster species having a perpendicular polarization being created, as well as the amount of silver cluster species having a perpendicular polarization being dissolved. The sum amount of silver cluster species in FIG. 9A together with FIG. 9B that are being created is nearly equal to the sum of those silver cluster species being dissolved.

The phenomenon discussed in the paragraphs immediately above also were observed in the corresponding spectral curve A of the lighter blue area and in the corresponding spectral curves B and C of the lighter red bleached area of the PBR plate No. 8A.

It was determined experimentally that when the intensity of a bleaching write beam is increased by a factor of 10, the required duration of write beam exposure pulse to produce the same extent of bleaching is reduced by a factor of 25. In other words, the sensitivity of the photosensitive glass layer of the PBR glass plate increases by a factor of 2.5 when the write beam intensity is increased by a factor of 10.

The red laser light bleached areas of a PBR glass plate is permanently stable in room lighting conditions and is also permanently stable in ambient atmosphere at 0 to 100% humidity levels.

### Dynamic Range of Index Modulation Δ(Δn) in a PBR Glass Plate

Diminishing certain species of silver clusters with a simultaneous creation of other silver cluster species results in the photo adaptation phenomenon also referred to herein as color adaptation. Photo adaptation is manifested as a spectral change, for example from spectral curve A of the light blue color area of plate 8A to the spectral curve B and C of the light red color area, see FIG. 8. The net spectral change from spectral curve A to spectral curve B and C of FIG. 8 may be qualitatively interpreted as a shift of the wavelength of the characteristic absorption band of the photosensitive glass layer of a PBR glass plate. For example, the peak wavelength of the spectral absorption band in plate No. 8A is shifted from 700 nm (λₚ₂ of spectral curve A) to 520 nm (λₚ₁ of spectral curve B).

The changes in Δn value, Δ(Δn), arising from λₚ being shifted from 700 nm to 520 nm are shown as a function of Dₚ value in FIG. 7 for selected wavelengths of holographic read. Examples of Δ(Δn) values shown in FIG. 7 are:
(1) Δ(Δn) values of a PBR glass plate having plasmon resonance absorption with a Dₚ value of 1.2 per 10 μm thickness of the photosensitive glass layer are 0.00823, 0.00794, and 0.00765 at wavelengths of 633 nm, 785 nm, and 830 nm respectively.
(2) Δ(Δn) values of a PBR glass plate having a Dₚ value of 1.75 per 10 μm thickness of the photosensitive glass layer are 0.0115, 0.0097, and 0.00824 at wavelengths of 633 nm, 785 nm, and 830 nm respectively.
(3) Δ(Δn) values of a PBR glass plate having a Dₚ value of 2.35 per 10 μm thickness of the photosensitive glass layer are 0.0162, 0.0135, and 0.0112 at wavelengths of 633 nm, 785 nm, and 830 nm respectively.
(4) Δ(Δn) values of a PBR glass plate having a Dₚ value of 2.85 per 10 μm thickness of the photosensitive glass layer are 0.0209, 0.0171, and 0.0147 at wavelengths of 633 nm, 785 nm, and 830 nm respectively.

Δ(Δn) values larger than 10⁻³ indicate that the dynamic range of refractive index modulation can support multiplex recording and reconstruction of information light utilizing holography. Namely, a number of high efficiency holograms can be recorded in the same volume of a PBR glass plate using a photo-energy bleaching mode of recording. In one embodiment, the thickness of the photosensitive glass layer is more than about 10 μm, for example, 100 to 200 μm.

### Exemplary Holographic Recording and Reconstruction

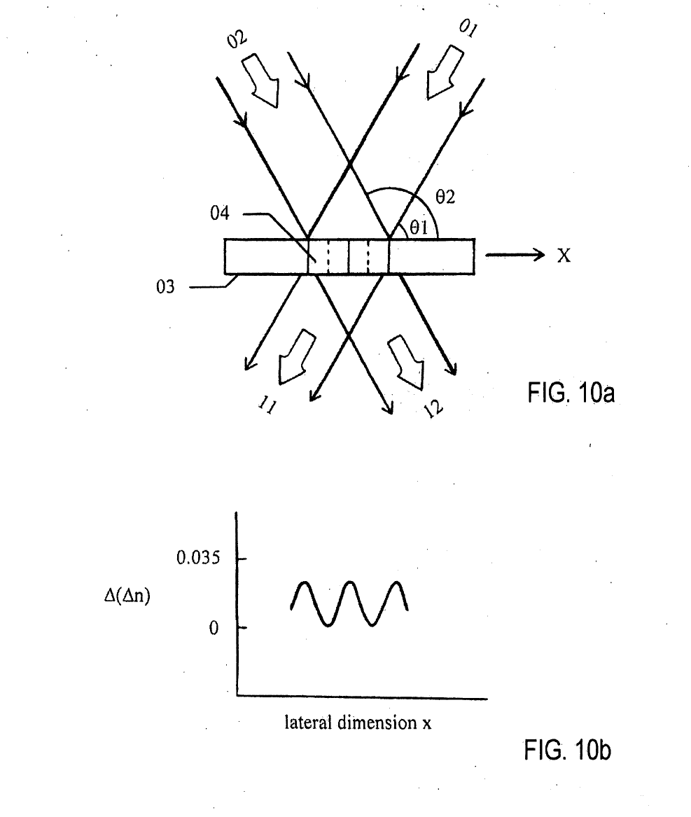

A periodical pattern of Δ(Δn) was produced in a photosensitive glass layer of a PBR glass plate by the interference of two red laser beams launched on the flat surface of the PBR glass plate. FIG. 10a depicts the propagation directions of laser write beams that have interferenced within the photosensitive glass layer of the PBR glass plate; when two laser write beams 01 and 02 were launched at incident angles of θ1 and θ2 on the flat surface of the photosensitive glass layer 03. Write beams 01 and 02 interacted with the photosensitive glass layer 03 and underwent attenuation, becoming transmitted beams 11 and 12 respectively. The write beams 01 and 02 formed periodical distribution of light intensity in the photosensitive glass layer 03. As shown in FIGS. 10a and 10b, this periodical variation of red light intensity results in a corresponding periodical variation of refractive index Δ(Δn) in the photosensitive glass layer 03 of the PBR glass plate. This periodical structure of Δ(Δn) is a phase volume transmitting diffractive grating, indicated by reference numeral 04 of FIG. 10a. The index modulation Δ(Δn) along the lateral dimension x of the photosensitive glass layer 03 is shown in FIG. 10b. This grating diffracts an incident read-beam if wavelength and incident angle satisfy Bragg conditions.

Holographic recording and reconstruction were carried out using the PBR glass plate No. 8A as the optical information recording medium. Volume holographic gratings resulting from interference of two plane waves, an object beam (that is, an information beam) and a reference beam were recorded in the light blue area having a Dₚ value of 1.2 and also were recorded in the lighter blue area with a Dₚ value of 0.72 in the PBR glass plate No. 8A, which had a photosensitive glass layer of 78 μm thickness. Both the object and the reference beams were the output of a single HeNe laser without spatial filtering, and each was about 10 mW on the glass surface, and also was of about 1.5 mm beam diameter with a Gaussian intensity profile. Volume holographic gratings of different exposure durations were recorded in the light blue areas and also in the lighter blue areas under room lighting conditions. Among the various recording durations that were utilized, the results of read back signal are discussed below for the reconstruction of information light from the volume holographic gratings recorded with exposure durations of 5 sec and 1 sec.

Reconstruction of information light utilizing holography was demonstrated by reducing the reference beam intensity to 0.1 milliwatt (without the information beam), with the wavelength of the read beam being that of the write beam at 633 nm. Signal to noise ratio of the reconstructed information beam were 53 and 32 from the gratings recorded in the light blue area using exposure durations 5 sec and 1 sec respectively, and the signal to noise ratio were 46 and 42 from the gratings recorded in the lighter blue area with exposure durations of 5 sec and 1 sec respectively.

The little increase in signal to noise ratio of the reconstructed information light with an exposure duration exceeding about 1 second in the lighter blue area may imply that an exposure dosage of 1.698 joule/cm², corresponding to a 1 sec exposure duration in the hologram recording, nearly bleached and effected photo adaptation to a saturation state in the lighter blue areas and that a Δ(Δn) value of 6.93×10⁻³ at 785 nm, is obtained corresponding to the saturation state of photo adaptation in the lighter blue area.

A large number of reads, equivalent to 10¹⁰ reads, were demonstrated by having read beam on continuously for 42 days.

The simple experiment of recording and reconstructing information light utilizing the holography described above demonstrated the index modulation in photo energy bleaching mode of recording in a PBR glass plate. It is noted that the signal to noise of the reconstructed information light can readily be improved at least in the following aspects:

Recording beams were not spatial filtered and have a Gaussian intensity profile, that is, not a preferred flat top beam.

The optical set up was not on a vibration isolation table that would adequately filter out vibrations for better hologram recordings.

Holographic recordings were performed under room lighting conditions, moreover, during holographic reconstruction stray light level was simply minimized by covering the optical set-up with a cover made of a large cardboard box without covering the bulky sized He—Ne laser, and a 0.5″ diameter opening on the cardboard box enabled the passage of the laser beam to enter the optical set up. The stray light level within a would-be optimized holographic recording system such as a holographic optical disc drive, would readily be improved by orders of magnitude.

A holographic optical disc drive for recording data in a photosensitive glass layer of a PBR glass plate includes at least one light source for generating a reference beam and an information beam. The reference beam is preferably a red laser beam of constant phase. The holographic drive includes a photosensitive glass layer of a PBR glass plate as an optical information recording medium in a path of the reference beam and in a path of the information beam. The holographic optical information recording medium may also include a data reflective surface, produced by coating a reflective surface on a plane beneath the photosensitive glass layer of the PBR glass plate. For example, a reflective film is coated on the back surface (i.e. second surface) of the PBR glass plate.

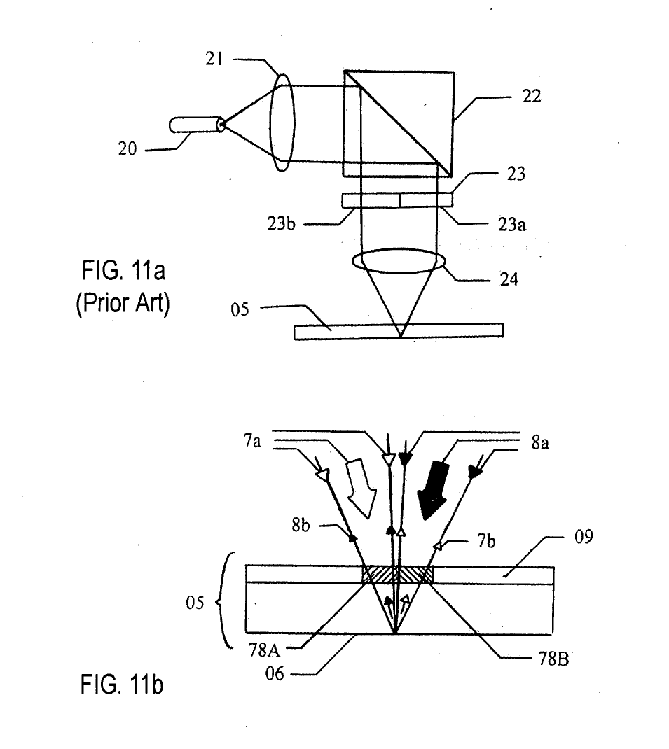

In a holographic optical disc drive such as those described in U.S. Pat. Nos. 6,909,529 and 6,995,882, which are incorporared herein by reference, the reference beam and the information beam interfere in the holographic medium to create a hologram only after at least one of the reference beam and the information beam have reflected off the data reflective surface. The prior art holographic optical disc drive of the '882 patent is depicted in FIG. 11a, and is briefly described herein below. As shown in FIG. 11a, during recording, a laser 20 projects coherent light through a collimation lens 21, into a beam splitter 22 and towards a spatial light modulator (SLM) 23. A bitmapped pattern to be recorded is displayed in region 23a, and region 23b is made transparent. In this way, light incident on region 23b generates a reference beam and light incident on region 23a generates the information beam. The reference and the information beams then pass through objective lens 24 to reflective holographic recording medium 05 to record a hologram therein. Thus, the holographic optical disc drive of the '882 patent relies on shift multiplexing to store a relatively large number of holograms in the holographic medium 05. As shown in FIG. 11b, holographic optical information recording medium 05 that is a PBR glass plate, is made reflective by including a reflective surface 06 on a plane beneath the photosensitive glass layer 09. In this way, a first hologram of the data input via incident information beam 8a is formed in region 78A by reflected information beam 8b interfering with incident reference beam 7a. A second hologram of the input data is formed in region 78B by incident information beam 8a interfering with reflected reference beam 7b. Holographic recording medium 05 is in the form of a disk which can be spatially translated to allow multiple holograms to be recorded therein with significant overlap between holograms.

In the above described holographic optical disc drive, one may use a 200 mW diode laser at, for example, a 650 nm wavelength to record a hologram of 0.1 mm diameter on a PBR glass plate by using a surface power of 20 mW each of an information beam and of a reference beam (i.e. 20% efficiency on disc from laser output). The intensity of the recording beam is increased by a factor of 450, that is, (20/10)(1.5/0.1)², from that of the exemplary holographic recording experiment described above. It was determined experimentally that the sensitivity of the bleaching mode of recording in a PBR glass plate increases by a factor of 2.5 when the intensity of the red bleaching beam is increased by a factor of 10.

Based on the above described non-linear effect of the write beam intensity on the bleaching sensitivity, the bleaching sensitivity is increased by a factor of 11.37 due to the increase in intensity level by a factor of 450. Therefore, a sum of 149 mJ/cm² (that is, 1.698/11.37) total exposure dosage can effectively record multiple holograms within the same volume of the lighter blue area in the photosensitive glass layer of the PBR plate No. 8A. The required energy density to record a single hologram is thus less than about 15 mJ/cm², since more than 10 holograms can be recorded with a dynamic range in index modulation Δ(Δn) of, for example, 6.93×10⁻³ at a read wavelength of 785 nm.

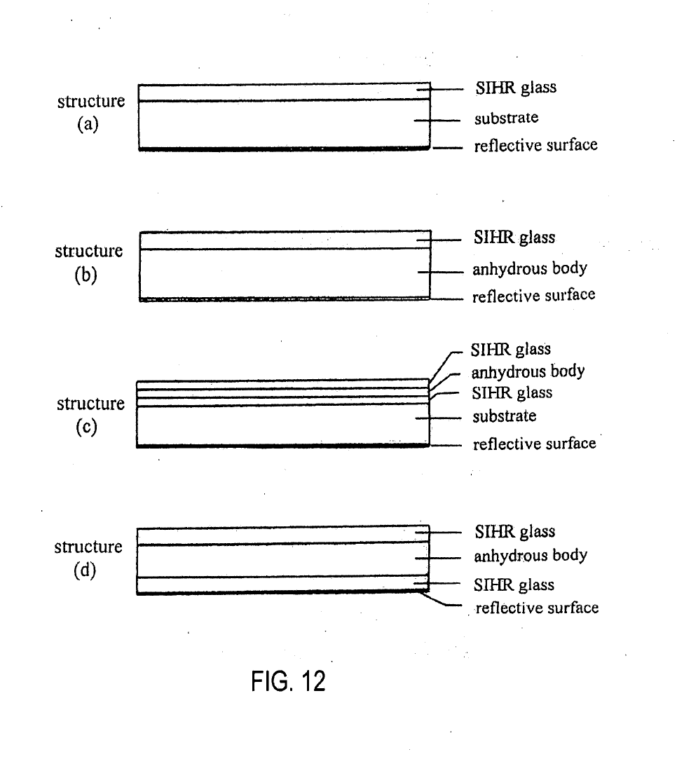

Holographic recording medium 05 of FIG. 11b with or without a data reflective layer was referred to interchangeably in the present disclosure as a holographic medium, as an optical information recording medium, or as a holographic optical information recording medium. The optical information recording medium 05 of the present invention comprises at least one photosensitive glass layer of either a PBR glass plate or a PDR glass plate. The structure of the optical information recording medium 05 may be so designed that it can be advantageously adapted to be installed in an optical system such as a holographic optical disc drive. Among numerous potential structural variations of the optical information recording medium 05, four of the exemplary structures are depicted in FIG. 12. To be compatible with conventional optical disc drives such as a DVD drive, the sum of thicknesses of all layers in the holographic recording medium can be for example 0.6 mm or 1.2 mm.

Structure (a) of FIG. 12 comprises a SIHR glass, a substrate, and a reflective surface. The SIHR glass represents a photosensitive glass layer of either a PBR glass plate or a PDR glass plate which is produced by ion-exchange through the entire thickness dimension of a base glass plate having a base glass composition. The thickness of the SIHR glass is more than about 5 μm, for example 200 μm. The substrate is in general a substrate of plastic or any other material which is transparent to write beams and read beam.

Structure (b) of FIG. 12 comprises a SIHR glass, an anhydrous body and a reflective surface. The SIHR glass together with the anhydrous glass body having the base glass composition represent either a PBR glass plate or a PDR glass plate.

Structure (c) of FIG. 12 comprises a SIHR glass, an anhydrous body, a second layer of SIHR glass, a substrate and a reflective surface. The anhydrous glass body portion together with two surface glass layer of SIHR glass represent either a PBR glass plate or a PDR glass plate.

Structure (d) of FIG. 12 comprises a SIHR glass, an anhydrous body, a second SIHR glass and a reflective surface. The anhydrous glass body portion together with two SIHR glass layer represent either a PBR glass plate or a PDR glass plate.

### Favorable Wavelength for Holographic Reconstruction

In performed experiments, the stability of red laser light bleached areas in room lighting conditions indicated that the intensity of the recording beam exceeded a certain intensity threshold. Therefore, reproduction of information light can be done using a read beam at the recording wavelength with a reduced intensity from that of the recording beams, or using a read beam at whose wavelength the photosensitive glass layer has no bleaching and no darkening sensitivity, and/or has a more favorable intensity threshold, and/or has a lower optical density value (i.e. has a higher transmittance value), and/or has a larger Δ(Δn) value.

### Volume Holographic Optical Element and Diffractive Optical Element

One application of a PDR glass plate and/or a PBR glass plate having a volume phase hologram recorded therein is to provide a volume diffractive optical element or as a volume holographic optical element.

The use of a volume diffractive optical elements as an angular selector, spatial filter, attenuator, switcher, modulator, beam splitter, beam sampler, beam deflector (controlled by the positioning of a grating matrix, small-angle master deflector, or spectral scanning), selector of particular wavelengths, notch filter, add/drop element, spectral shape former (gain equalizer), spectral sensor (wavelength meter/wavelocker), angular sensor (pointing locker), Bragg spectrometer (spectral analyzer), or as a transversal and longitudinal mode selector in a laser resonator was described in U.S. Pat. No. 6,673,497, issued on Jun. 6, 2004 to Efimov et al, which is incorporated herein by reference.

### Computer-Generated Holograms (CGHs) As Holographic or Diffractive Optical Elements

Instead of using two laser write beams to record an interference pattern in the photosensitive glass layer to produce a diffractive optical element and/or a holographic optical element, a diffractive optical element and/or a holographic optical element in either a PDR glass plate or a PBR glass plate can be produced as a computer-generated hologram (CGH) using a laser beam or an electron beam pattern generator to write on the photosensitive glass layer of a PDR or a PBR glass plate. Moreover, CGHs can be mass-produced in a PBR or a PDR glass plate using a gray scale photomask. The gray scale optical density pattern of a CGH can either be written using an electron beam pattern generator in a HEBS glass plate, or using a laser beam pattern generator in a Laser Direct Write (LDW) glass plate to generate a HEBS-glass gray scale photomask or a LDW-glass gray scale photomask respectively.

The fabrication of HEBS-glass gray scale photomasks and LDW-glass gray scale photomasks was disclosed in U.S. Pat. No. 6,562,523, issued on May 13, 2003 to Wu et al, which is incorporated herein by reference. CGHs in a PDR glass plate can be mass produced by exposing a PDR glass plate to a spatially modulated gray scale intensity pattern of the darkening-light radiation, formed by passing a plane wave of darkening-light radiation through a gray scale photomask containing the gray scale mask pattern of the CGH. Similarly, CGHs in a PBR glass plate can be mass produced by exposing a PBR glass plate to a spatially modulated gray scale intensity pattern of the bleaching-light radiation, formed by passing a plane wave of bleaching-light radiation through a gray scale photomask containing the gray scale mask pattern of the CGH.

Computer-generated holograms (CGHs) are used in a number of important optical technology application areas such as diffractive optics devices/diffractive optical elements, holographic optical elements, optical interconnect devices for high speed parallel processors, invariant correlation filters for object detection and recognition, optical processing and computing, optical testing, image and information displays, beam forming, and beam scanning. An overview of CGH applications and CGH fabrication methods and devices that is employed to fabricate CGHs, was discussed in an article “CGH Fabrication Techniques and Facilities” by J. N. Cederquist et al in SPIE Vol. 884 Computer Generated Holography II (1988). The content of this article is incorporated herein by reference.

A method of forming a computer-generated hologram (CGH) according to the present invention includes the steps of:
(a) making a photo-darkenable-refractive (PDR) glass plate having at least one photosensitive glass layer of a silver ion-exchanged holographic recording (SIHR) glass, which has a base glass composition that has been ion-exchanged in an aqueous ion-exchange solution containing silver ions, causing the photosensitive glass layer of the PDR glass plate to show a refractive index change upon exposure to darkening-light radiation; and
(b) exposing the photosensitive glass layer of the PDR glass plate to the darkening-light radiation to form the CGH in the photosensitive glass layer of the PDR glass plate. Such darkening-light radiation can be an interference pattern of an information beam and a reference beam, or can be a spatially modulated gray scale intensity pattern of the darkening-light radiation, formed by passing a plane wave of darkening-light radiation through a gray scale photomask. The gray scale photomask is a HEBS glass gray scale photomask, a LDW glass gray scale photomask, or another gray scale photomasks. Alternatively, a CGH can also be formed by exposure to darkening-light radiation of a PDR glass plate bit-by-bit to a spatially modulated gray scale dosage pattern of the CGH. The CGH can be used as a diffractive optical element or as a holographic optical element. The diffractive optical element or the holographic optical element may be a beam splitter, a spectral shape former, a beam sampler, an angular selector, a spatial filter, an attenuator, a switcher, a modulator, a beam deflector, a selector of particular wavelengths, a spectral sensor, an angular sensor, or a Bragg spectrometer.

In another embodiment, a method of forming a computer-generated hologram (CGH) according to the present invention includes the step of:
(a) making a photo-bleachable-refractive (PBR) glass plate having at least one photosensitive glass layer of a silver ion-exchanged holographic recording (SIHR) glass, which has a base glass composition that has been ion exchanged in an aqueous ion-exchange solution containing silver ions, and which has been darkened uniformly at least in lateral (x, y) dimensions (that is, perpendicular to the direction of the glass plate) with darkening-light radiation, causing the photosensitive glass layer of the PBR glass plate to show instantaneously a refractive index change upon exposure to bleaching-light radiation; and
(b) exposing the photosensitive glass layer of the PBR glass plate to the bleaching-light radiation to form the CGH in the photosensitive glass layer of the PBR glass plate.

The bleaching-light radiation may be an interference pattern of an information beam and a reference beam, or may be a spatially modulated gray scale intensity pattern of the bleaching-light radiation written bit-by-bit on the PBR glass plate, or the entire gray scale intensity pattern being formed by passing a plane wave of bleaching-light radiation through a gray scale photomask. Such gray scale photomask may be a HEBS glass gray scale photomask, a LDW glass gray scale photomask, or another gray scale photomasks. The CGH can be used as a diffractive optical element or as a holographic optical element. The diffractive optical element or the holographic optical element may be a beam splitter, a spectral shape former, a beam sampler, an angular selector, a spatial filter, an attenuator, a switcher, a modulator, a beam deflector, a selector of particular wavelengths, a spectral sensor, an angular sensor, or a Bragg spectrometer.

One product of the present invention is a volume holographic optical element that includes a photo-bleachable-refractive (PBR) glass plate having at least one photosensitive glass layer of a SIHR glass, which has a base glass composition that has been ion-exchanged in an aqueous ion-exchange solution containing silver ions, and which has been darkened uniformly at least in lateral (x, y) dimensions (that is, perpendicular to the depth dimension z of ion exchange reaction) with darkening-light radiation, causing the photosensitive glass layer of the PBR glass plate to show a refractive index change upon exposure to bleaching-light radiation without any post-exposure step such as a physical or a chemical treatment; and that also includes appropriate devices for forming the volume holographic optical element in the PBR glass. The volume holographic optical element is formed either by exposing the PBR glass plate to the interference pattern of two laser write beams, or is produced as a CGH using either a laser beam pattern generator or an electron beam pattern generator to write bit-by-bit on the PBR glass plate, or is produced using a gray scale photomask. The volume holographic optical element may be a beam splitter, a spectral shape former, a beam sampler, an angular selector, a spatial filter, an attenuator, a switcher, a modulator, a beam deflector, a selector of particular wavelengths, a spectral sensor, an angular sensor, or a Bragg spectrometer.

Another product of the present invention is a volume holographic optical element that includes a photo-darkenable-refractive (PDR) glass plate having at least one photosensitive glass layer of a SIHR glass, which has a base glass composition that has been ion-exchanged in an aqueous ion-exchange solution containing silver ions, causing the photosensitive glass layer of the PDR glass plate to show a refractive index change upon exposure to darkening-light radiation without any post-exposure step such as a physical or a chemical treatment; and that includes appropriate devices for forming the volume holographic optical element in the PDR glass. The volume holographic optical element is formed either by exposing the PDR glass plate to the interference pattern of two laser write beams, or is produced as a CGH using either a laser beam pattern generator or an electron beam pattern generator to write bit-by-bit on the PDR glass plate, or is produced using a gray scale photomask. The volume holographic optical element may be a beam splitter, a spectral shape former, a beam sampler, an angular selector, a spatial filter, an attenuator, a switcher, a modulator, a beam deflector, a selector of particular wavelengths, a spectral sensor, an angular sensor, or a Bragg spectrometer.

### Transformation of Gray Scale Optical Density Pattern Into Gray Scale Height Profile of Surface Relief

Optical density patterns in a PDR glass plate and in a PBR glass plate were transformed into gray scale height profiles of surface relief with a chemical etching step. Differential etch rates among various optical density levels are a manifestation of different concentrations of elemental silver species in the SIHR glass matrix. The chemical etching is selected from wet chemical etching in aqueous solution containing HF, and dry chemical etching using fluorine containing gas such as CH₃F.

Three dimensional microstructures including refractive micro optical elements such as microlens arrays and diffractive micro elements such as fresnel lenses can be mass produced economically using a PDR or a PBR glass plate.

In one embodiment of the present invention, a three dimensional microstructure according to the present invention includes the steps of:
(a) making a photo-darkenable-refractive (PDR) glass plate having at least one photosensitive glass layer of a silver ion-exchanged holographic recording (SIHR) glass which has a base glass composition that has been ion-exchanged in an aqueous ion-exchange solution containing silver ions, causing the photosensitive glass layer of the PDR glass plate to show a gray scale optical density pattern upon exposure to a spatially modulated intensity pattern of darkening-light radiation;
(b) exposing the photosensitive glass layer of the PDR glass plate to the darkening-light radiation to form the gray scale optical density pattern in the photosensitive glass layer of the PDR glass plate, the spatially modulated gray scale intensity pattern of darkening-light radiation being formed by passing a plane wave of darkening-light radiation through a gray scale photomask having pre-designed gray scale levels corresponding to gray scale height levels of the three dimensional microstructure. The gray scale photomask is a HEBS-glass gray scale photomask or a LDW-glass gray scale photomask or another gray scale photomask; and
(c) chemically etching the optical density pattern in the PDR glass plate to form the three dimensional microstructure.

### Optical Information Recording Medium

One application of a PBR glass plate is as an optical information recording medium; similarly, an application of a PDR glass plate is as an optical information recording medium.

Such an optical information recording medium may be employed as a holographic recording material. Moreover, the optical information recording medium can also be employed as a gray scale bit-by-bit recording material to store data bits with gray levels or a gray scale image and/or pattern, in which each bit may have an optical density level of 2 or more gray scale levels. A large number of gray scale levels can be utilized because of the very large dynamic range of photo induced optical density change and/or refractive index change in a PDR glass plate.

The gray scale image and/or pattern having data bits with gray levels in a PDR or a PBR glass plate can be mass produced via use of a gray scale photomask including a HEBS-glass gray scale photomask, a LDW-glass gray scale photomask, or other types of photomask.

While the invention has been described in connection with the above described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become obvious to those skilled in the art and the scope of the present invention is limited only by the appended claims.

What is claimed is:

1. A method of forming a volume phase hologram comprising:
producing a photo-bleachable-refractive (PBR) glass plate having at least one photosensitive glass layer made of a silver ion-exchanged holographic recording (SIHR) glass, the SIHR glass having a base glass composition that has been subjected to ion-exchange in an aqueous ion-exchange solution containing silver ions, the SIHR glass having been darkened uniformly at least in its lateral dimensions that are perpendicular to the photosensitive glass layer, with darkening-light radiation, the photosensitive glass layer of the PBR glass plate showing a refractive index change upon exposure to a bleaching-light radiation; and
exposing the at least one photosensitive glass layer of the PBR glass plate to the bleaching-light radiation of laser write beams to form the volume phase hologram in the photosensitive glass layer of the PBR glass plate.

2. The method of claim 1, wherein the base glass composition consists essentially, in mole percent of the oxide basis, of 10-23% of one or more alkali metal oxides, about 4-18% ZnO, zero to about 4% MgO, about 0.5-10% Al₂O₃, about 0.2 to 3.5% Cl, and about 54 to 78% SiO₂.

3. The method of claim 1,
wherein the base glass composition consists essentially, in mole percent of the oxide basis, of 8-28% of one or more alkali metal oxides, zero to about 24% ZnO, zero to about 10% Al₂O₃, zero to about 12% MgO, zero to about 8% ZrO₂, zero to about 10% CaO, zero to about 20% PbO, zero to about 15% B₂O₃, zero to about 30% P₂O₅, zero to 4% TiO₂, about 0.1-9% Cl, zero to about 3% total of one or more of F, Br, or I, and about 50 to 86% SiO₂, and
wherein one or more of ZnO, ZrO₂, Al₂O₃, MgO, TiO₂, or PbO are about 5% to 35% in mole percent of the oxide basis, and
wherein the base glass composition has a concentration of the one or more of ZnO, ZrO₂, Al₂O₃, MgO, TiO₂, or PbO effective to render the photosensitive glass layer free of any thermoplastic property that adversely affects the dimensional stability of the photosensitive glass layer for multiplex recording or reproduction of information utilizing holography.

4. The method of claim 3, wherein the base glass composition contains at least about 4% of ZnO in mole percent of the oxide basis.

5. The method of claim 3, wherein the base glass composition contains at least about 0.5% of one or more of Al₂O₃, ZrO₂, or TiO₂ in mole percent of the oxide basis.

6. The method of claim 1, wherein the darkening-light radiation is produced by an ultraviolet lamp, and wherein the darkening-light radiation has at least one wavelength between 250 nm and about 450 nm.

7. The method of claim 1, wherein the darkened SIHR glass has a thickness of about 5 or more micrometers.

8. The method of claim 7, wherein absorption losses in the SIHR glass at selected read wavelengths are limited by causing the wavelength λₚ of at least one prominent absorption peak of atomic silver clusters in the SIHR glass to shift to a shorter wavelength as exposure dosage of the darkening-light radiation on the SIHR glass is increased.

9. The method of claim 1, wherein the aqueous ion exchange solution contains at least one oxidizing agent.

10. The method of claim 9, wherein the oxidizing agent is selected from the group consisting of HNO₃ and one or more metal nitrates.

11. The method of claim 10, wherein the one or more metal nitrates are selected from the group consisting of AgNO₃, LiNO₃, NaNO₃, KNO₃, and Zn(NO₃)₂.

12. The method of claim 1, wherein the aqueous ion-exchange solution is acidic.

13. The method of claim 1, wherein the laser write beams have a wavelength between about 500 nm and about 750 nm.

14. The method of claim 1, wherein the photosensitive glass layer of the PBR glass plate is exposed using an exposure dosage of the bleaching-light radiation of the laser write beams between about 10 mJ/cm² and about 5,000 mJ/cm².

15. The method of claim 1, further comprising the step of installing the PBR glass plate as an optical information recording medium or as a portion of the optical information recording medium to produce a holographic optical disc drive.

16. The method of claim 15, wherein the photosensitive glass layer of the PBR glass plate is a hologram layer in the optical information recording medium.

17. The method of claim 16, wherein the laser write beams consist of an information light beam and a reference light beam.

18. The method of claim 17, wherein information light in the information light beam is reconstructed using a laser read beam, and the wavelength of the laser read beam is between about 500 nm and about 1100 nm.

19. The method of claim 18, wherein the properties of the photosensitive glass layer of the PBR glass plate are balanced to have essentially no darkening sensitivity and essentially no bleaching sensitivity at the read wavelength and/or at an intensity level of the laser read beam.

20. The method of claim 18, wherein the properties of the photosensitive glass layer of the PBR glass plate are balanced to generate a value of the refractive index change at the wavelength of the laser read beam sufficient for multiplex reproduction of the information light utilizing holography.

21. The method of claim 18, wherein the properties of the photosensitive glass layer of the PBR glass plate are balanced to generate a value of transmittance at the wavelength of the laser read beam sufficient for multiplex reproduction of the information light utilizing holography.

22. The method of claim 21, wherein the properties of the photosensitive glass layer of the PBR glass plate are balanced by balancing the composition of the SIHR glass to cause the wavelength λₚ of at least one prominent absorption peak of atomic silver clusters in the SIHR glass to shift to a shorter wavelength as the exposure dosage of the darkening-light radiation on the SIHR glass is increased.

23. The method of claim 18, wherein the laser read beam has the wavelength of the laser write beams and has a fraction of the intensity of the reference light beam.

24. A method of forming a volume phase hologram comprising:
producing a photo-darkenable-refractive (PDR) glass plate having at least one photosensitive glass layer made of a silver ion-exchanged holographic recording (SIHR) glass, the SIHR glass having a base glass composition that has been subjected to ion-exchange in an aqueous ion-exchange solution containing silver ions, the photosensitive glass layer of the PDR glass plate showing a refractive index change upon exposure to a darkening-light radiation; and
exposing the at least one photosensitive glass layer of the PDR glass plate to the darkening-light radiation of laser write beams to form the volume phase hologram in the photosensitive glass layer of the PDR glass plate.

25. The method of claim 24, wherein the base glass composition consists essentially, in mole percent of the oxide basis, of about 10-23% of one or more alkali metal oxides, about 4-18% ZnO, about 0.5-12% MgO, about 0.5-10% Al₂O₃, about 0.2-3.5% Cl, or about 54-78% SiO₂.

26. The method of claim 24,
wherein the base glass composition consists essentially, in mole percent of the oxide basis, of 8-28% of one or more alkali metal oxides, zero to about 24% ZnO, zero to about 10% Al₂O₃, zero to about 12% MgO, zero to about 8% ZrO₂, zero to about 10% CaO, zero to 20% PbO, zero to 15% B₂O₃, zero to 30% P₂O₅, zero to 4% TiO₂, 0.1-9% Cl, zero to 3% of one or more of F, Br, or I, and about 50 to 86% SiO₂,
wherein one or more of ZnO, ZrO₂, Al₂O₃, MgO, TiO₂, or PbO are about 5 to 35% in mole percent of the oxide basis, and
wherein the base glass composition has a concentration of the one or more of ZnO, ZrO₂, Al₂O₃, MgO, TiO₂, or PbO effective to render the photosensitive glass layer free of any thermoplastic property that adversely affects the dimensional stability of the photosensitive glass layer for multiplex recording or for reproduction of holographically stored information.

27. The method of claim 26, wherein the base glass composition contains at least 4% of ZnO in mole percent of the oxide basis.

28. The method of claim 26, wherein the base glass composition contains at least 2% of MgO in mole percent of the oxide basis.

29. The method of claim 26, wherein the base glass composition contains at least 0.5% of Al₂O₃ in mole percent of the oxide basis.

30. The method of claim 24, wherein in the at least one photosensitive glass layer has a thickness of the SIHR glass of about 5 or more micrometers.

31. The method of claim 24, wherein absorption losses in the SIHR glass at selected read wavelengths are limited by causing the wavelength λₚ, of at least one prominent absorption peak of atomic silver clusters in the SIHR glass to shift to a shorter wavelength as exposure dosage of the darkening-light radiation on the SIHR glass is increased.

32. The method of claim 24, wherein the aqueous ion-exchange solution contains at least one oxidizing agent.

33. The method of claim 32, wherein the oxidizing agent is selected from the group consisting of HNO₃ and one or more metal nitrates.

34. The method of claim 33, wherein the one or more metal nitrates are selected from the group consisting of AgNO₃, LiNO₃, NaNO₃, KNO₃, and Zn(NO₃)₂.

35. The method of claim 24, wherein the aqueous ion-exchange solution is acidic.

36. The method of claim 24, wherein the laser write beams have a wavelength between about 250 nm and about 550 nm.

37. The method of claim 24, wherein the at least one photosensitive glass layer is exposed using exposure dosages of the darkening-light radiation of the laser write between about 10 mJ/cm² and about 20,000 mJ/cm².

38. The method of claim 37, wherein the exposure dosage required to form the volume phase hologram is reduced by varying concentration of MgO in the base glass composition.

39. The method of claim 24, further comprising the step of installing the PDR glass plate as an optical information recording medium or as a portion of an optical information recording medium to produce a holographic optical disc drive.

40. The method of claim 39, wherein the photosensitive glass layer of the PDR glass plate is a hologram layer in the optical information recording medium.

41. The method of claim 40, wherein the laser write beams consist of an information light beam and a reference light beam.

42. The method of claim 41, wherein information light in the information light beam is reconstructed using a laser read beam that has a wavelength between about 500 nm and about 1100 nm.

43. The method of claim 42, wherein the properties of the photosensitive glass layer of the PDR glass plate are balanced to have essentially no darkening sensitivity and essentially no bleaching sensitivity at the read wavelength and/or at an intensity level of the laser read beam.

44. The method of claim 42, wherein the properties of the photosensitive glass layer of the PDR glass plate are balanced to generate a value of the refractive index change at the wavelength of the laser read beam sufficient for multiplex reproduction of the information light utilizing holography.

45. The method of claim 42, wherein the properties of the photosensitive glass layer of the PDR glass plate are balanced to generate a value of transmittance at the wavelength of the laser read beam sufficient for multiplex reproduction of the information light utilizing holography.

46. The method of claim 45, wherein the properties of the photosensitive glass layer of the PDR glass plate are balanced by balancing the composition of the SIHR glass to cause the wavelength λₚ of at least one prominent absorption peak of atomic silver clusters in the SIHR glass to shift to a shorter wavelength as the exposure dosage of the darkening-light radiation on the SIHR glass is increased.

47. The method of claim 42, wherein the laser read beam has a wavelength of about 780 nm.

48. A method of forming a computer-generated hologram (CGH) comprising:
producing a photo-bleachable-refractive (PBR) glass plate having at least one photosensitive glass layer made of a silver ion-exchanged holographic recording (SIHR) glass, the SIHR glass having a base glass composition that has been subjected to ion exchange in an aqueous ion-exchange solution containing silver ions, the SIHR glass having been darkened uniformly at least in its lateral dimensions that are perpendicular to the photosensitive glass layer with darkening-light radiation, the photosensitive glass layer of the PBR glass plate showing a change in refractive index upon exposure to bleaching-light radiation; and
exposing the photosensitive glass layer of the PBR glass plate to the bleaching-light radiation to form the CGH in the photosensitive glass layer of the PBR glass plate.

49. The method of claim 48, wherein the bleaching-light radiation is an interference pattern of an information light beam and a reference light beam.

50. The method of claim 48, wherein the bleaching-light radiation comprises a spatially modulated gray scale intensity pattern formed by passing a plane wave of bleaching-light radiation through a gray scale photomask.

51. The method of claim 48, wherein the photosensitive glass layer is exposed bit-by-bit to a spatially modulated gray scale dosage pattern of the bleaching-light radiation to form the CGH.

52. The method of claim 48, wherein the CGH is a diffractive optical element or a holographic optical element.

53. A method of forming a computer-generated hologram (CGH) comprising:
producing a photo-darkenable-refractive (PDR) glass plate having at least one photosensitive glass layer of a silver ion-exchanged holographic recording (SIHR) glass, the SIHR glass having a base glass composition that has been subjected to ion-exchange in an aqueous ion-exchange solution containing silver ions, the photosensitive glass layer of the PDR glass plate showing a refractive index change upon exposure to darkening-light radiation; and
exposing the at least one photosensitive glass layer of the PDR glass plate to the darkening-light radiation to form the CGH in the photosensitive glass layer of the PDR glass plate.

54. The method of claim 53, wherein the darkening-light radiation is an interference pattern of an information light beam and a reference light beam.

55. The method of claim 53, wherein the darkening-light radiation comprises a spatially modulated gray scale intensity pattern formed by passing a plane wave of darkening-light radiation through a gray scale photomask.

56. The method of claim 53, wherein the photosensitive glass layer is exposed bit-by-bit to a spatially modulated gray scale dosage pattern of the darkening-light radiation to form the CGH.

57. A method of claim 53, wherein the CGH is a diffractive optical element or a holographic optical element.

58. A method of forming a three dimensional microstructure comprising:
producing a photo-darkenable-refractive (PDR) glass plate having at least one photosensitive glass layer made of a silver ion-exchanged holographic recording (SIHR) glass, the SIHR glass having a base glass composition that has been subjected to ion-exchange in an aqueous ion-exchange solution containing silver ions, so to cause the at least one photosensitive glass layer of the PDR glass plate to form a gray scale optical density pattern therein upon exposure to a spatially modulated intensity pattern of darkening-light radiation;
exposing the photosensitive glass layer of the PDR glass plate to the darkening-light radiation to form the gray scale optical density pattern in the at least one photosensitive glass layer of the PDR glass plate, the spatially modulated gray scale intensity pattern of the darkening-light radiation being formed by passing a plane wave of the darkening-light radiation through a gray scale photomask having pre-designed gray scale optical density levels corresponding to gray scale height levels of the three dimensional microstructure, the gray scale photomask being a high energy beam sensitive-glass gray scale photomask or a laser direct write-glass gray scale photomask or another gray scale photomask; and
chemically etching the optical density pattern in the PDR glass plate to form the three dimensional microstructure.

59. The method of claim 58, wherein the three dimensional microstructure is selected from the group consisting of refractive micro-optical elements and diffractive micro-optical elements.
